(19) United States
(12) Patent Application Publication
(10) Pub. No.: US 2016/0116740 A1
(43) Pub. Date: Apr. 28, 2016

(54) DISPLAY DEVICE, CONTROL METHOD FOR DISPLAY DEVICE, DISPLAY SYSTEM, AND COMPUTER PROGRAM

(71) Applicant: SEIKO EPSON CORPORATION, Tokyo (JP)

(72) Inventors: Tatsunori TAKAHASHI, Shiojiri-shi (JP); Masahide TAKANO, Matsumoto-shi (JP)

(21) Appl. No.: 14/878,545

(22) Filed: Oct. 8, 2015

(30) Foreign Application Priority Data
Oct. 24, 2014 (JP) 2014-217270
Jun. 22, 2015 (JP) 2015-124440

(51) Int. Cl. G02B 27/01; G06F 3/01

(52) U.S. Cl. CPC G02B 27/0172; G06F 3/011; G02B 27/0179; G02B 2027/014; G02B 2027/0138; G02B 2027/0132

(57) ABSTRACT

A head-mounted display device includes a storing unit, a first camera and a biological-information detecting unit functioning as an input unit, and an information-display control unit. The storing unit stores setting information concerning display of the display unit in association with identification information for identifying a user. The first camera functioning as the input unit picks up an image of a hand of the user. The biological-information detecting unit functioning as the input unit extracts biological information from the picked-up image. The information-display control unit controls the display of the display unit on the basis the setting information corresponding to the input biological information.

### BACKGROUND

1. Technical Field

The present invention relates to a display device, a control method for the display device, a display system, and a computer program.

2. Related Art

There have been known display devices of a head mounted type. Among the display devices of this type, there is a display device with which a user wearing the device can perform setting concerning the operation of the device (see, for example, JP-A-2002-159019 (Patent Literature 1)). Patent Literature 1 discloses a display device that is mounted on the head of a player (a user) and can perform more natural display by aligning display positions of images.

As explained above, the display device of the head mounted type can prevent, for example, deterioration in feeling of use due to an individual difference of a user by adjusting display positions of images. However, it is complicated to perform the adjustment every time the user uses the display device. Further, for example, when a plurality of users share the display device, each of the users has to perform the adjustment every time the user wears the display device. Therefore, a burden of operation is large.

### SUMMARY

An advantage of some aspects of the invention is to reduce a burden on a user when a display device set according to the user.

A display device according to an aspect of the invention includes a display unit of a head mounted type, the display device including: a storing unit configured to store setting information concerning display of the display unit in association with identification information for identifying a user; an input unit configured to input the identification information; and a control unit configured to control the display of the display unit on the basis the setting information corresponding to the input identification information.

According to the aspect of the invention, it is possible to perform setting related to the display of the display device on the basis of the setting information. Therefore, it is possible to quickly perform setting adjusted to the user.

The display device according to the aspect of the invention may further include an image pickup unit. The input unit may input the identification information based on a picked-up image picked up by the image pickup unit. The control unit may specify the identification information corresponding to the identification information input by the input unit among the identification information stored in the storing unit and control the display of the display unit on the basis of the setting information stored in association with the specified identification information.

According to the aspect of the invention with this configuration, it is possible to perform the setting related to the display of the display device using the picked-up image. Therefore, it is possible to quickly perform the setting adjusted to the user.

In the display device according to the aspect of the invention, the identification information stored by the storing unit may include a part of features included in biological information of the user.

According to the aspect of the invention with this configuration, it is possible to identify the user using the biological information as the identification information. Since the identification information includes a part of the features included in the biological information of the user, it is possible to reduce an information amount and perform simple setting corresponding to physical features.

In the display device according to the aspect of the invention, the control unit may collate a part of the features of the biological information input as the identification information by the input unit and a part of the features of the biological information stored by the storing unit to specify the setting information.

According to the aspect of the invention with this configuration, it is possible to perform simple setting corresponding to physical features.

In the display device according to the aspect of the invention, the identification information may include image information related to an image extracted from the picked-up image picked up by the image pickup unit.

According to the aspect of the invention with this configuration, it is possible to perform the setting related to the display of the display device using the image extracted from the picked-up image.

In the display device according to the aspect of the invention, the control unit may collate the image information included in the identification information input by the input unit and the image information stored by the storing unit to specify the setting information.

According to the aspect of the invention with this configuration, it is possible to simply execute authentication using the image extracted from the picked-up image and perform the setting related to the display of the display device.

In the display device according to the aspect of the invention, the identification information may include first identification information including a part of features included in biological information of the user and second identification information configured by the image information. The storing unit may store the first identification information, the second identification information, and the setting information in association with one another.

According to the aspect of the invention with this configuration, it is possible to perform the setting related to the display of the display device using the biological information and information related to the image extracted from the picked-up image. It is possible to properly use more kinds of setting information by combining a plurality of kinds of information.

In the display device according to the aspect of the invention, the control unit may specify, on the basis of the first identification information and the second identification information included in the identification information input by the input unit, the setting information stored in the storing unit.

According to the aspect of the invention with this configuration, it is possible to properly use more kinds of setting by combining the biological information and the information related to the image extracted from the picked-up image.

In the display device according to the aspect of the invention, the control unit may specify the setting information stored in the storing unit in association with a combination of the first identification information and the second identification information included in the identification information input by the input unit.

According to the aspect of the invention with this configuration, it is possible to properly use more kinds of setting by combining the biological information and the information related to the image extracted from the picked-up image.

In the display device according to the aspect of the invention, the control unit may select, on the basis of one of the first identification information and the second identification information included in the identification information input by the input unit, a plurality of kinds of the setting information from the setting information stored in the storing unit and specify, among the selected setting information, the setting information corresponding to the other of the first identification information and the second identification information included in the identification information input by the input unit.

According to the aspect of the invention with this configuration, it is possible to specify the setting information in two steps using a plurality of kinds of information. It is possible to efficiently properly use more kinds of setting.

In the display device according to the aspect of the invention, the image information may be information extractable or detectable from the picked-up image and is non biological inherent information not including information, which alone enables individual identification of an organism.

According to the aspect of the invention with this configuration, it is possible to select setting stored in advance and perform the setting related to the display of the display device using the information not including the information, which alone enables individual identification of an organism.

In the display device according to the aspect of the invention, the image information may include any one of outside scene information obtained by extracting information including a shape of a building from the picked-up image including the building, object information for identification extracted from the picked-up image obtained by picking up an image of a non-biological object for identification, and track information related to a track of an object extracted from a plurality of the picked-up images obtained by picking up images of a moving object.

According to the aspect of the invention with this configuration, it is possible to select setting stored in advance and perform the setting related to the display of the display device using the picked-up image including the building, the picked-up image obtained by picking up the non-biological object for identification, or the plurality of picked-up images obtained by picking up images of the moving object.

In the display device according to the aspect of the invention, the display unit may be capable of switching and executing binocular display for displaying an image to correspond to the right eye and the left eye of the user and monocular display for displaying an image to correspond to one of the right eye and the left eye of the user. The control unit may cause, on the basis of the setting information corresponding to the identification information input by the input unit, the display unit to perform monocular display before controlling the display of the display unit and switch the display unit to binocular display when controlling the display on the basis of the setting information.

According to the aspect of the invention with this configuration, it is possible to reduce a sense of discomfort of the user while setting is not reflected on the display of the display unit.

In the display device according to the aspect of the invention, the display unit may transmit an outside scene and display an image to be visually recognizable together with the outside scene. The control unit may change at least one of a display position and a display size of the image in a plurality of steps according to the setting information.

According to the aspect of the invention with this configuration, it is possible to set the display position and the display size of the image stepwise according to the user.

In the display device according to the aspect of the invention, the display unit may include: an optical element that transmits an outside scene and makes image light incident on the eyes of the user to be visually recognizable together with the outside scene; a target detecting unit that detects a target object in a visual line direction of the user; and a position detecting unit that detects a position of the target object with respect to a display region of the display unit. The control unit may change a display position of the image by the optical element according to the position of the target object detected by the position detecting unit and a positional relation between the optical element and the positions of the pupils of the user.

According to the aspect of the invention with this configuration, it is possible to set the display position of the image according to the user.

In the image display device according to the aspect of the invention, the setting information may include information concerning setting of a language. The control unit may cause the display unit to display characters of the language corresponding to the setting information when displaying contents including characters on the display unit.

According to the aspect of the invention with this configuration, it is possible to set, according to the user, the language of the characters displayed on the display unit.

The display device according to the aspect of the invention may further include a communication unit. The control unit may transmit, with the communication unit, the setting information and the identification information stored in the storing unit to an external apparatus in association with each other, receive the setting information and the identification information with the communication unit, and store the received setting information and the received identification information in the storing unit in association with each other.

According to the aspect of the invention with this configuration, it is possible to transmit the setting information and the identification information to the external apparatus or receive the setting information and the identification information from the external apparatus. Consequently, it is possible to easily acquire and store the setting information and the identification information and share the setting information and the identification information with the external apparatus.

A display system according to another aspect of the invention includes a plurality of display devices, each including a display unit of a head mounted type. The display device includes: a storing unit configured to store setting information concerning display of the display unit in association with identification information for identifying a user; an input unit configured to input the identification information; a control unit configured to control the display of the display unit on the basis the setting information corresponding to the input identification information; and a communication unit configured to communicate with the other display devices. The control unit transmits, with the communication unit, the setting information and the identification information stored in the storing unit in association with each other, receives the setting information and the identification information with the communication unit, and stores the received setting information and the received identification information in the storing unit in association with each other.

According to the aspect of the invention, it is possible to perform setting related to the display of the display device on the basis of the setting information. Therefore, it is possible to quickly perform setting adjusted to the user. Further, since the setting information and the identification information are transmitted and received between the display devices, it is possible to share the setting information and the identification information among the plurality of display devices.

A control method for a display device according to still another aspect of the invention includes a display unit of a head mounted type, the control method including: inputting identification information; controlling, referring to a storing unit that stores setting information concerning display of the display unit in association with identification information for identifying a user, the display of the display unit on the basis of the setting information corresponding to the input identification information.

According to the aspect of the invention, it is possible to perform setting related to the display of the display device on the basis of the setting information. Therefore, it is possible to quickly perform setting adjusted to the user.

A computer program according to yet another aspect of the invention is a computer program executable by a computer that controls a display device including a display unit of a head mounted type, the computer program causing the computer to function as: an input unit configured to input identification information; and a control unit configured to control, referring to a storing unit that stores setting information concerning display of the display unit in association with identification information for identifying a user, the display of the display unit on the basis of the setting information corresponding to the input identification information.

According to the aspect of the invention, it is possible to perform setting related to the display of the display device on the basis of the setting information. Therefore, it is possible to quickly perform setting adjusted to the user.

### BRIEF DESCRIPTION OF THE DRAWINGS

The invention will be described with reference to the accompanying drawings, wherein like numbers reference like elements.

FIG. 1 is a schematic configuration diagram of a communication system and a display system in a first embodiment.

FIG. 2 is an explanatory diagram showing the exterior configuration of a head-mounted display device.

FIG. 3 is a plan view showing a light guide plate.

FIG. 4 is a functional block diagram of units configuring the head-mounted display device.

FIGS. 5A and 5B are schematic diagrams showing configuration examples of a user information table.

FIG. 6 is a flowchart for explaining the operation of the head-mounted display device in an information registration mode.

FIGS. 7A and 7B show an example of an image displayed by the head-mounted display device in the information registration mode, wherein FIG. 7A shows an example of a silhouette image and FIG. 7B shows an example of adjustment performed using the silhouette image.

FIG. 8 is a flowchart for explaining the operation of the head-mounted display device for registering user information.

FIG. 9 shows, as an example of an image displayed by the head-mounted display device, an example in which an additional guide is displayed on the silhouette image.

FIGS. 10A to 10C are schematic diagrams showing configuration examples of communication data.

FIG. 11 is a flowchart for explaining the operation of a head-mounted display device in a second embodiment.

FIGS. 12A and 12B are diagrams showing examples of message outputs by the head-mounted display device.

FIG. 13 is a flowchart for explaining the operation of a head-mounted display device in a third embodiment.

FIG. 14 is a flowchart for explaining the operation of a head-mounted display device in a fourth embodiment.

FIG. 15 is a diagram showing a display example of the head-mounted display device in the fourth embodiment.

FIG. 16 is a flowchart showing the operation of a head-mounted display device in a fifth embodiment.

FIG. 17 is a diagram showing an example of a user information table stored by the head-mounted display device in the fifth embodiment.

FIGS. 18A to 18C are diagrams showing examples of images recognized by the head-mounted display device in the fifth embodiment.

FIG. 19 is a flowchart for explaining the operation of a head-mounted display device in a sixth embodiment.

FIG. 20 is a diagram showing an example of a user information table stored by the head-mounted display device in the sixth embodiment.

### DESCRIPTION OF EXEMPLARY EMBODIMENTS

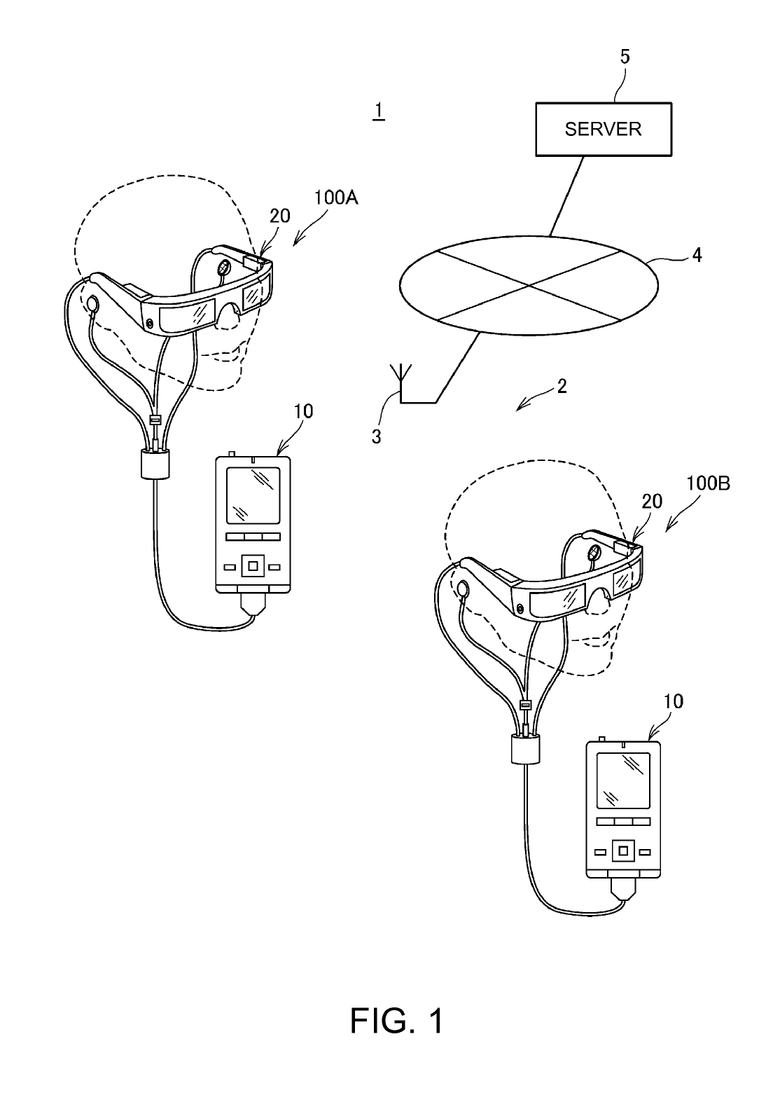

FIG. 1 is a schematic configuration diagram showing the configuration of a communication system 1 as an embodiment applied with the invention. The communication system 1 is a system in which a display system 2 including a plurality of head-mounted display devices 100 is connected to a server 5 via a communication network 4.

The head-mounted display device 100 is a display device worn on the head by a user as shown in FIG. 1 and is also called head mounted display (HMD). The head-mounted display device 100 is a head-mounted display device of an optical transmission type with which the user can directly visually recognize an outside scene simultaneously with visually recognizing a virtual image.

Note that, in the following explanation, the virtual image visually recognized by the user with the head-mounted display device 100 is also referred to as “display image” for convenience. Emitting image light generated on the basis of image data is also referred to as “display an image”.

In FIG. 1, the plurality of head-mounted display devices 100 included in the display system 2 are respectively represented as head-mounted display devices 100A and 100B. In the following explanation, when it is unnecessary to distinguish the head-mounted display devices 100A and 100B, the head-mounted display devices 100A and 100B are described as head-mounted display device 100.

The communication network 4 is realized by various communication lines such as a public line network, a leased line, a radio communication line including a cellular phone line, and a backbone communication line of these lines or a combination of the communication lines. A specific configuration of the communication network 4 is not limited. The communication network 4 may be a wide area communication line network that can connect remote places or may be a LAN (Local Area Network) laid in a specific facility or building. The communication network 4 may include a network apparatus such as a server apparatus, a gateway apparatus, or a router apparatus that connects the various communication lines. The communication network 4 may be configured by a plurality of communication lines.

The display system 2 is configured using a LAN or the like set in a building or the like. The display system 2 includes a radio access point 3 that performs radio communication and the plurality of head-mounted display devices 100A and 100B. The radio access point 3 is a communication apparatus such as an access point or a router and relays data communication between the head-mounted display device 100A and the head-mounted display device 100B and data communication between the head-mounted display devices 100A and 100B and the communication network 4.

The head-mounted display device 100A can execute data communication with the other head-mounted display device 100B via the radio access point 3. The head-mounted display devices 100A and 100B execute data communication with the server 5 via the radio access point 3. Note that the head-mounted display device 100A may directly execute radio communication with the other head-mounted display device 100B in, for example, an ad-hoc mode. The head-mounted display devices 100A and 100B may be connected by a wired communication line.

That is, the configuration of the display system 2 is not particularly limited as long as the head-mounted display device 100A can communicate with the head-mounted display device 100B. The communication system 1 only has to have a configuration in which the head-mounted display devices 100A and 100B included in the display system 2 and the server 5 can communicate with each other.

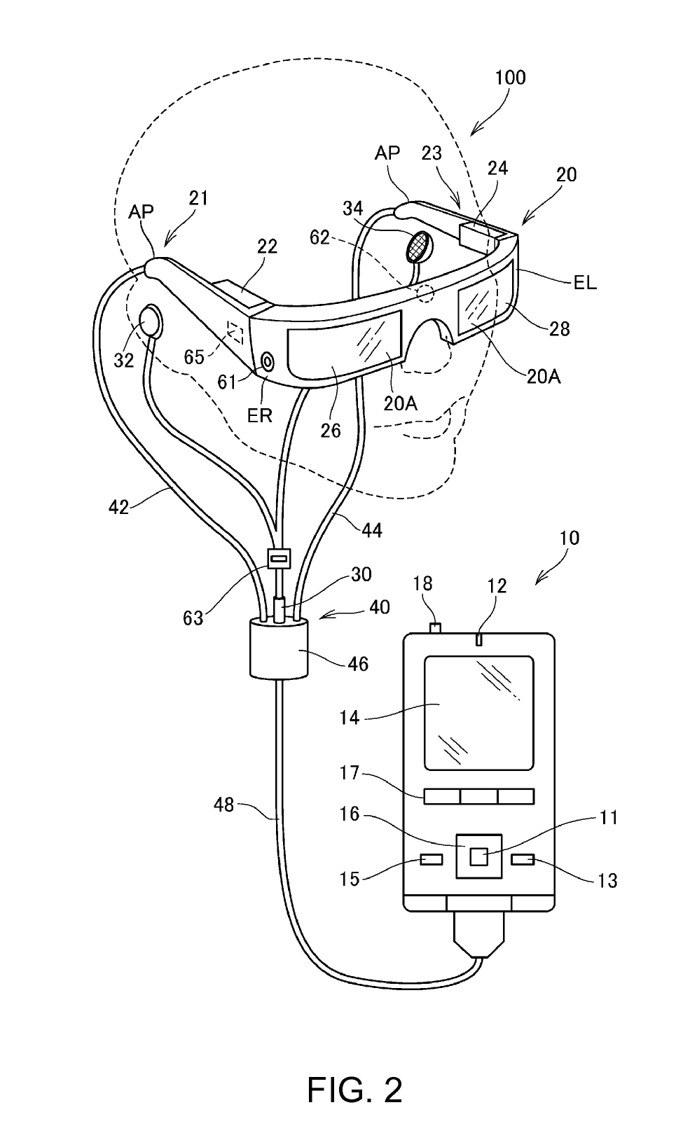

FIG. 2 is an explanatory diagram showing the exterior configuration of the head-mounted display device 100. Since the head-mounted display devices 100A and 100B have a common configuration, the head-mounted display devices 100A and 100B are explained as the head-mounted display device 100 below.

The head-mounted display device 100 includes an image display unit 20 that causes the user to visually recognize a virtual image in a state in which the image display unit 20 is worn on the head of the user and a control device 10 that controls the image display unit 20. The control device 10 also functions as a controller with which the user operates the head-mounted display device 100.

The image display unit 20 is a wearing body worn on the head of the user. In this embodiment, the image display unit 20 has an eyeglass shape. The image display unit 20 includes a right holding unit 21, a right display driving unit 22, a left holding unit 23, a left display driving unit 24, a right optical-image display unit 26, a left optical-image display unit 28, a first camera 61, a second camera 62, and a microphone 63. The right optical-image display unit 26 and the left optical-image display unit 28 are disposed to be respectively located in front of the right eye and in front of the left eye of the user when the user wears the image display unit 20. One end of the right optical-image display unit 26 and one end of the left optical-image display unit 28 are connected to each other in a position corresponding to the middle of the forehead of the user when the user wears the image display unit 20.

The right holding unit 21 is a member provided to extend from an end portion ER, which is the other end of the right optical-image display unit 26, to a position corresponding to the temporal region of the user when the user wears the image display unit 20. Similarly, the left holding unit 23 is a member provided to extend from an end portion EL, which is the other end of the left optical-image display unit 28, to a position corresponding to the temporal region of the user when the user wears the image display unit 20. The right holding unit 21 and the left holding unit 23 hold the image display unit 20 on the head of the user like temples of eyeglasses.

The right display driving unit 22 and the left display driving unit 24 are disposed on sides opposed to the head of the user when the user wears the image display unit 20. Note that the right display driving unit 22 and the left display driving unit 24 are collectively simply referred to as “display driving unit” as well and the right optical-image display unit 26 and the left optical-image display unit 28 are collectively simply referred to as “optical-image display unit” as well.

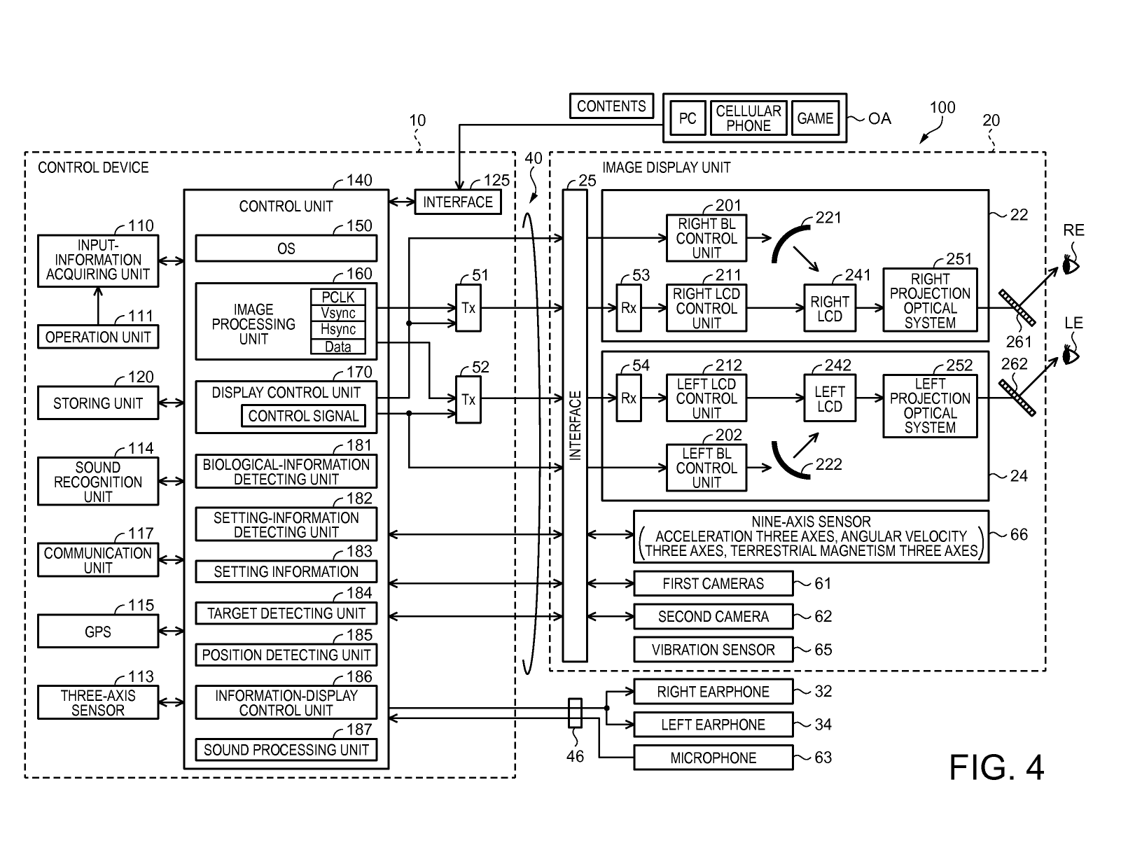

The display driving units 22 and 24 include liquid crystal displays 241 and 242 (hereinafter referred to as “LCDs 241 and 242” as well) and projection optical systems 251 and 252 (see FIG. 4). Details of the configuration of the display driving units 22 and 24 are explained below. The optical-image display units 26 and 28 functioning as optical members include light guide plates 261 and 262 (see FIG. 4) and dimming plates 20A. The light guide plates 261 and 262 are formed of light transmissive resin or the like and guide image lights output from the display driving units 22 and 24 to the eyes of the user. The dimming plates 20A are thin plate-like optical elements and are disposed to cover the front side of the image display unit 20, which is a side opposite to the side of the eyes of the user. As the dimming plates 20A, various dimming plates such as a dimming plate, light transmissivity of which is approximately zero, a dimming plate that is nearly transparent, a dimming plate that attenuates a light amount and transmits light, and a dimming plate that attenuates or reflects light having a specific wavelength can be used. By appropriately selecting optical characteristics (light transmittance, etc.) of the dimming plates 20A, it is possible to adjust an amount of external light made incident on the right optical-image display unit 26 and the left optical-image display unit 28 from the outside and adjust easiness of visual recognition of a virtual image. In the following explanation in this embodiment, the dimming plates 20A having light transmissivity enough for enabling the user wearing the head-mounted display device 100 to visually recognize a scene on the outside are used. The dimming plats 20A protect the right light guide plate 261 and the left light guide plate 262 and suppresses damage, adhesion of stain, and the like to the right light guide plate 261 and the left light guide plate 262.

The dimming plates 20A may be detachably attachable to the right optical-image display unit 26 and the left optical-image display unit 28. A plurality of kinds of the dimming plates 20A may be replaceable and detachably attachable. Alternatively, the dimming plats 20A may be omitted.

The first camera 61 functioning as an input unit is disposed at the end portion ER, which is the other end of the right optical-image display unit 26. The first camera 61 picks up an image of an outside scene, which is a scene on the outside, in a direction on the opposite side of the side of the eyes of the user, and acquires an outside scene image. The first camera 61 may be either a monocular camera or a stereo camera.

An image pickup direction, that is, an angle of view of the first camera 61 is a front side direction of the head-mounted display device 100, in other words, a direction for picking up at least a part of an outside scene in a visual field direction of the user in a state in which the head-mounted display device 100 is mounted. The width of the angle of view of the first camera 61 can be set as appropriate. However, it is desirable that an image pickup range of the first camera 61 is a range including the outside world visually recognized by the user through the right optical-image display unit 26 and the left optical-image display unit 28. Further, it is more desirable that the image pickup range of the first camera 61 is set such that the first camera 61 can pick up an image of the entire visual field of the user through the dimming plates 20A.

The second camera 62 is disposed in a boundary portion between the right optical-image display unit 26 and the left optical-image display unit 28, that is, an intermediate position of the left and right eyes of the user. The second camera 62 faces the inner side of the image display unit 20 and picks up an image on the side of the eyes of the user. The second camera 62 may be either a monocular camera or a stereo camera.

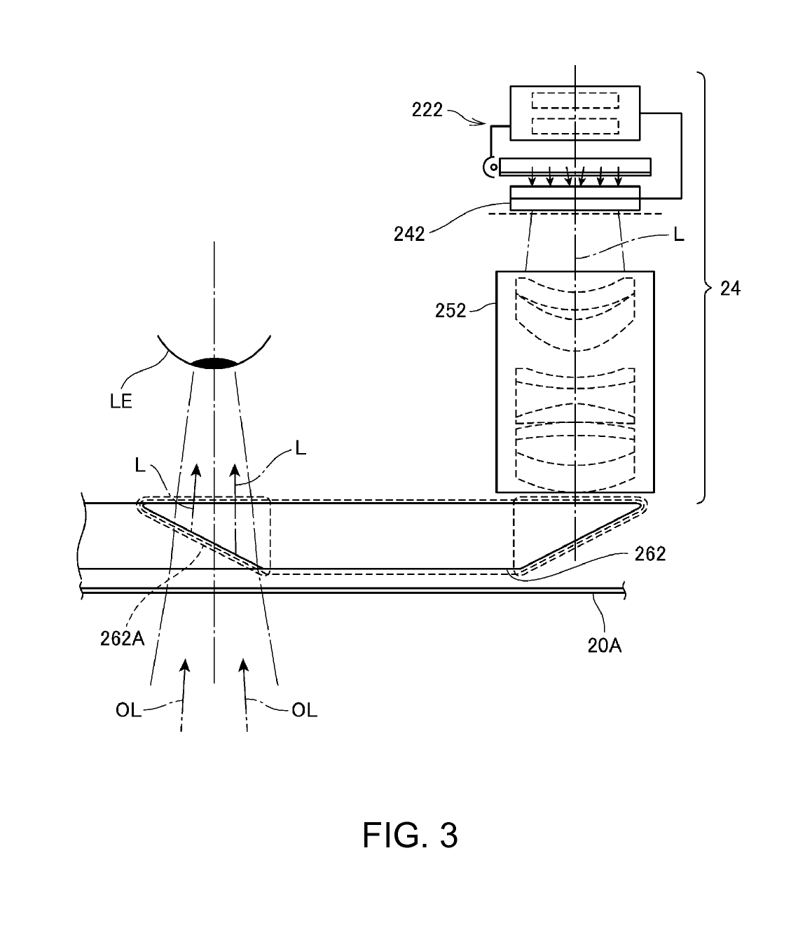

FIG. 3 shows the configuration of the left light guide plate 262 as a plan view. A configuration for causing the left eye and the right eye of the user to visually recognize a virtual image is symmetrical. Therefore, only the left light guide plate 262 is explained. Since the right light guide plate 261 is symmetrical to the left light guide plate 262 shown in FIG. 3, illustration and explanation of the right light guide plate 261 are omitted.

The left display driving unit 24 of the image display unit 20 includes a left backlight 222 including a light source such as an LED and a diffuser and the transmissive left LCD 242 disposed on an optical path of light emitted from the diffuser of the left backlight 222. The left display driving unit 24 of the image display unit 20 includes a left projection optical system 252 including a lens group that guides image light L transmitted through the left LCD 242.

The left projection optical system 252 is configured by a collimate lens that changes the image light L emitted from the left LCD 242 to light beams in a parallel state. The image light L changes to the light beams in the parallel state is made incident on the left light guide plate 262. The left light guide plate 262 is a prism in which a plurality of reflection surfaces for reflecting the image light L are formed. The image light L is guided to the left eye LE side through a plurality of times of reflection in the inside of the left light guide plate 262. The image light L reflected on a half mirror 262A located in front of the left eye LE is emitted toward the left eye LE from the left optical-image display unit 28. The image light L focuses an image on the retina of the left eye LE and causes the user to visually recognize the image.

Note that the left projection optical system 252 and the left guide plate 262 are collectively referred to as “light guide unit” as well. As the light guide unit, any system can be used as long as the light guide unit forms a virtual image in front of the eyes of the user using image light. For example, a diffraction grating may be used or a transreflective film may be used.

Not only the image light L reflected on the half mirror 262A but also external light OL transmitted through the dimming plate 20A is made incident on the left eye LE of the user. That is, the head-mounted display device 100 superimposes the image light L of an image processed on the inside and the external light OL one on top of the other and makes the image light L and the external light OL incident on the eyes of the user. For the user, an outside scene is seen through the dimming plates 20A of the head-mounted display device 100. An image by the image light L is visually recognized over the outside scene. That is, the head-mounted display device 100 can be considered a see-through type display device.

Although not shown in the figure, the right light guide plate 261 includes a half mirror 261A. The half mirror 261A is symmetrical to the half mirror 262A shown in FIG. 3.

An image pickup direction, that is, an angle of view of the second camera 62 shown in FIG. 2 is a rear side direction of the head-mounted display device 100, in other words, a direction for picking up the face of the user in a state in which the head-mounted display device 100 is mounted. The second camera 62 can pick up an image of the positions of the eyes of the user, an image of the distance between the eyes, and an image of the face (a face image) of the user. The width of the angle of view of the second camera 62 can be set as appropriate. However, it is desirable that the width is a range in which images of the face of the user wearing the head-mounted display device 100 and the half mirrors 261A and 262A can be picked up. Note that the angle of view of the second camera 62 only has to be an angle of view for enabling image pickup of optical elements such as the dimming plates 20A even if the angle of view is not the angle of view for enabling image pickup of the half mirrors 261A and 262A. A control unit 140 explained below calculates angles of the half mirrors 261A and 262A on the basis of the angle of the dimming plates 20A subjected to the image pickup.

Referring back to FIG. 2, the head-mounted display device 100 includes a connecting unit 40 for connecting the image display unit 20 to the control device 10. The connecting unit 40 includes a main body cord 48 connected to the control device 10, a right cord 42, a left cord 44, and a coupling member 46. The right cord 42 and the left cord 44 are two cords branching from the main body cord 48. The right cord 42 is inserted into a housing of the right holding unit 21 from a distal end portion AP in an extending direction of the right holding unit 21 and connected to the right display driving unit 22. Similarly, the left cord 44 is inserted into a housing of the left holding unit 23 from the distal end portion AP in an extending direction of the left holding unit 23 and connected to the left display driving unit 24.

The coupling member 46 is provided at a branching point of the main body cord 48 and the right cord 42 and the left cord 44 and includes a jack for connecting an earphone plug 30. A right earphone 32 and a left earphone 34 extend from the earphone plug 30. The microphone 63 is provided in the vicinity of the earphone plug 30. The cords are bundled as one cord between the earphone plug 30 and the microphone 63. The cords branch from the microphone 63 and are respectively connected to the right ear phone 32 and the left ear phone 34.

For example, as shown in FIG. 2, the microphone 63 is disposed such that a sound collecting unit of the microphone 63 faces a visual line direction of the user. The microphone 63 collects sound and outputs a sound signal to a sound processing unit 187 (FIG. 4). The microphone 63 may be, for example, either a monaural microphone or a stereo microphone, may be a microphone having directivity, or may be a non-directional microphone.

The right cord 42 and the left cord 44 can also be bundled as one cord. Specifically, a lead wire on the inside of the right cord 42 may be drawn into the left holding unit 23 side through the inside of a main body of the image display unit 20, coated with resin together with a lead wire on the inside of the left cord 44, and bundled as one cord.

The image display unit 20 and the control device 10 perform transmission of various signals via the connecting unit 40. Connectors (not shown in the figure) fitting with each other are provided at an end portion on the opposite side of the coupling member 46 in the main body cord 48 and provided in the control device 10. The control device 10 and the image display unit 20 are connected and disconnected according to fitting and unfitting of the connector of the main body cord 48 and the connector of the control device 10. As the right cord 42, the left cord 44, and the main body cord 48, for example, a metal cable or an optical fiber can be adopted.

The control device 10 controls the head-mounted display device 100. The control device 10 includes a determination key 11, a lighting unit 12, a display switching key 13, a luminance switching key 15, a direction key 16, a menu key 17, and switches including a power switch 18. Further, the control device 10 includes a track pad 14 touch-operated by the user with a finger.

The determination key 11 detects pressing operation and outputs a signal for determining content of operation by the control device 10. The lighting unit 12 notifies, with a light emitting state thereof, an operation state of the head-mounted display device 100. Examples of the operation state of the head-mounted display device 100 include ON/OFF of a power supply. As the lighting unit 12, for example, an LED (Light Emitting Diode) is used. The display switching key 13 detects pressing operation and outputs, for example, a signal for switching a display mode of a content moving image to 3D and 2D.

The track pad 14 detects operation by a finger of the user on an operation surface of the track pad 14 and outputs a signal corresponding to detection content. As the track pad 14, various track pads such as an electrostatic type, a pressure detection type, and an optical type can be adopted. The luminance switching key 15 detects pressing operation and outputs a signal for increasing or reducing the luminance of the image display unit 20. The direction key 16 detects pressing operation on keys corresponding to upward, downward, left, and right directions and outputs a signal corresponding to detection content. The power switch 18 detects slide operation of the switch to switch a power supply state of the head-mounted display device 100.

FIG. 4 is a functional block diagram of the units configuring the head-mounted display device 100.

As shown in FIG. 4, the head-mounted display device 100 is connected to the external apparatus OA via an interface 125. The interface 125 is an interface for connecting various external apparatuses OA, which are supply sources of contents, to the control device 10. As the interface 125, for example, interfaces corresponding to wired connection such as a USB interface, a micro USB interface, and an interface for a memory card can be used.

The external apparatus OA is used as an image supply apparatus that supplies an image to the head-mounted display device 100. For example, a personal computer (PC), a cellular phone terminal, or a gate terminal is used.

The control device 10 of the head-mounted display device 100 includes a control unit 140, an operation unit 111, an input-information acquiring unit 110, a storing unit 120, the interface 125, a transmitting unit (Tx) 51, and a transmitting unit (Tx) 52.

The operation unit 111 detects operation by the user. The operation unit 111 includes the determination key 11, the display switching key 13, the track pad 14, the luminance switching key 15, the direction key 16, the menu key 17, and the power switch 18 shown in FIG. 2.

The input-information acquiring unit 110 acquires a signal corresponding to an operation input by the user. Examples of the signal corresponding to the operation input include operation inputs to the track pad 14, the direction key 16, and the power switch 18. The control device 10 includes a power supply unit (not shown in the figure) and supplies electric power to the units of the control device 10 and the image display unit 20.

The storing unit 120 is a nonvolatile storage device and stores various computer programs. Image data to be displayed on the image display unit 20 of the head-mounted display device 100 may be stored in the storing unit 120.

The storing unit 120 stores a user information table in which user information is registered. The user information table is a table in which biological information (identification information) and setting information are registered in association with user IDs for identifying users. The biological information is information concerning an organism inherent in the user capable of specifying the user. The setting information is information concerning setting concerning display of the image display unit 20 and setting concerning the operation of the head-mounted display device 100. Details of the user information table are explained below.

For example, there is an individual difference in the distance between the eyes of the user and the half mirrors 261A and 262A depending on the height of the nose, the sizes of the eye sockets and the eye balls, and the like of the user. Some user has the left and right ears at different height. When the user wears the head-mounted display device 100, the image display unit 20 is not horizontal. A relative positional relation between the units of the image display unit 20 and the eyes of the user at the time when the image display unit 20 is worn is affected by an individual difference of an anatomical structure of the head of the user. Therefore, if the distances between the eyes of the user and the optical elements, the angles of the optical elements at the time when the head-mounted display device 100 is mounted, and the like are adjusted to match the body of the user, it is possible to absorb the individual difference and realize a satisfactory feeling of use.

Therefore, when the user wears the head-mounted display device 100 in this embodiment for the first time, the head-mounted display device 100 performs calibration according to the control by the control unit 140. The head-mounted display device 100 measures the distances between the eyes of the user and the optical elements, the angles of the optical elements at the time when the head-mounted display device 100 is mounted, and the like. The control unit 140 registers measured setting information of the user in the user information table. Further, the control unit 140 registers biological information capable of specifying the user in the user information table in association with the setting information of the user. When the user actually uses the head-mounted display device 100, the control unit 140 specifies the user on the basis of the biological information detected from a picked-up image picked up by the first camera 61. The head-mounted display device 100 adjusts, according to the specified setting information of the user, a display position and a display size of an image displayed by the image display unit 20.

Examples of the biological information used by the head-mounted display device 100 include a fingerprint, a palm print, a palm line, a blood vessel pattern of the retina, a picked-up image of the face, a picked-up image of the entire body, and voice. These kinds of information are information detectable by the first camera 61, the second camera 62, the microphone 63, and the like functioning as the input unit included in the head-mounted display device 100. The palm line is a figure formed by linear wrinkles (recesses) appearing on the palm or a combination of the wrinkles and refers to, for example, a line of so-called palmistry. Further, the absolute length of a hand, the length of a finger, a ratio of the length of a finger, and the like of the user can also be used.

In an example explained in this embodiment, biological information processable as an image is processed using the first camera 61 as the input unit. The head-mounted display device 100 extracts, from the biological information itself such as the fingerprint, the palm print, the palm line, the blood vessel pattern of the retina, the picked-up image of the face, or the picked-up image of the entire body, one or a plurality of kinds of feature information, which are biological features, and uses the extracted feature information. For example, when the biological information is the palm line, the feature information includes a plurality of kinds of information representing features of the biological information such as position coordinates of a start point and an end point, a length ratio, and a curvature of the palm line. In the example explained in this embodiment, the absolute length of a hand, a length ratio of a finger, an angle of a surface of a palm, and palm line information are used as the biological information.

The biological information used by the head-mounted display device 100 is registered in the user information table stored by the storing unit 120.

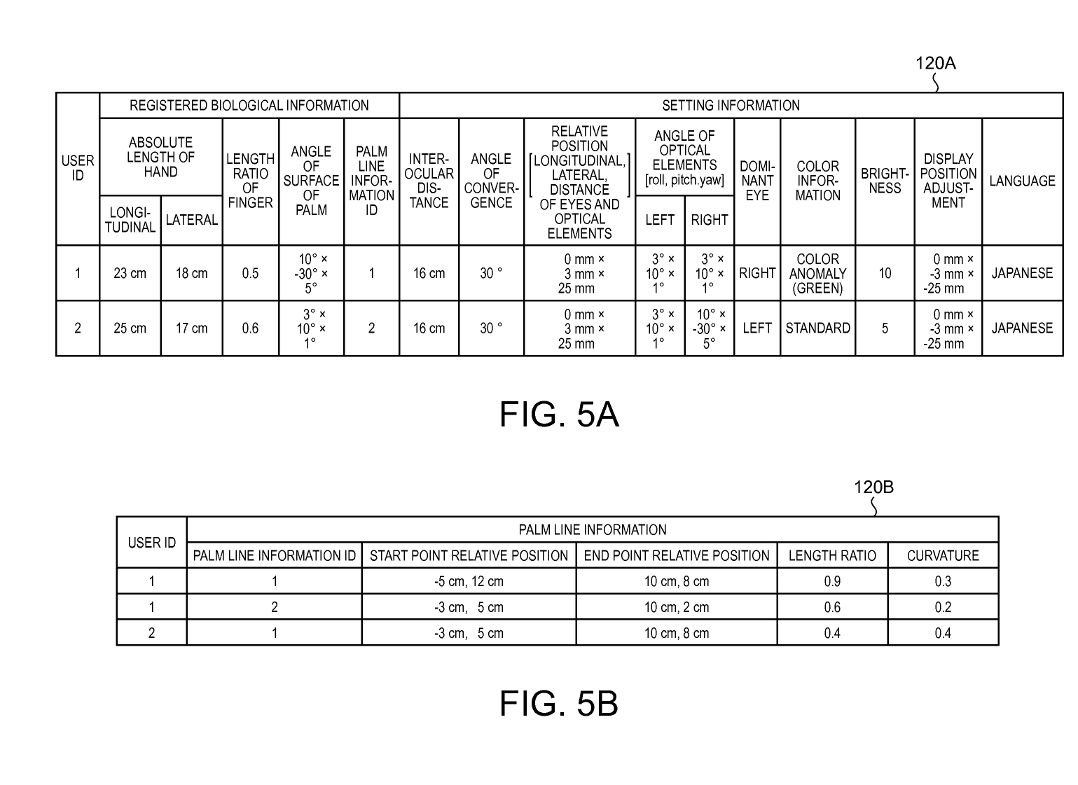

FIGS. 5A and 5B are schematic diagrams showing specific examples of the user information table stored by the storing unit 120 in this embodiment. FIG. 5A shows a user information table 120A. FIG. 5B shows a palm line information table 120B that complements information of the user information table 120A. The user information table 120A added with the palm line information table 120B is equivalent to the user information table in this embodiment.

The user information table 120A and the palm line information table 120B include, as the biological information, absolute length information of a hand, length ratio information of a finger, angle information of a surface of a palm, and palm line information. These kinds of biological information are detected by the control unit 140 on the basis of a picked-up image of a hand of the user picked up by the first camera 61. The biological information registered in the user information table 120A and the palm line information table 120B is referred to as, in particular, registered biological information.

The absolute length information of the hand includes the length in the longitudinal direction and the length in the latitudinal direction of the hand of the user (unit: cm). The length in the longitudinal direction of the hand is, for example, the length from the wrist to the middle finger. The length in the latitudinal direction is, for example, the width of the palm. The length ratio of the finger is the length of the finger with respect to the length in the longitudinal direction of the hand. As the length ratio of the finger, length ratios of the hands of the user may be registered or, for example, only a length ratio of the index finger may be registered.

The angle information of the surface of the palm is information indicating an angle of the palm at the time when the user holds the palm over the first camera 61. The angle is an angle based on an image pickup surface of the first camera 61 or the light guide plates 261 and 262 or the dimming plates 20A. The angle is, for example, an angle set to 0 degree when the surface is parallel to the image pickup surface, an angle of the half mirrors 261A and 262A of the light guide plates 261 and 262 with respect to the optical axis of the image light L, or an angle set to 0 degree when the surface is parallel to the dimming plates 20A. Measurement of the angle of the surface of the palm can be realized by, for example, measuring distances to a plurality of measurement points on the palm with the first camera 61 or a distance sensor when the first camera 61 is a stereo camera or when the head-mounted display device 100 includes the distance sensor.

The palm line information is information concerning the length of the palm line or a shape of a figure formed by the palm line. Since an information amount of the palm line information is large, the palm line information is registered in the palm line information table 120B, which is another table. The user information table 120A and the palm line information table 120B are tied by a palm line information ID. The head-mounted display device 100 can obtain a plurality of kinds of palm line information of the palm of the user on the basis of a picked-up image picked up by the first camera 61. In the palm line information table 120B shown in FIG. 5B, palm line IDs are given to main palm lines. Information concerning the positions and the lengths of the palm lines are stored in association with the palm line IDs. User IDs of users who detect the palm lines are registered in association with the user IDs.

The start point and end point coordinates of the palm line are a start coordinate and an end coordinate of the palm line based on the origin. The origin can be set in any position. For example, the upper left of a picked-up image of the hand of the user may be set as the origin. The upper left of a region of the hand of the user detected in a predetermined size from the picked-up image may be set as the origin. The length ratio of the palm line is the length of the palm line based on the length in the longitudinal direction of the hand. The curvature is a maximum value of a curvature in one palm line.

The biological information used as the registered biological information is not limited to the biological information listed in FIG. 5A. Easily measurable biological information such as an interocular distance, a color of the pupils, and a picked-up image of the face may be registered in the user information table 120A as simple biological information.

The setting information of the user information table 120A includes an interocular distance, an angle of convergence, a relative position of the eyes and the optical elements, an angle of the optical elements, a dominant eye, color information, brightness, a language in use, and display position adjustment information. The interocular distance may be a distance between the inner sides of the eyes of the user, that is, between the inner corners of the eyes or may be a distance between the centers of the pupils.

The relative position of the eyes and the optical elements is, for example, a value representing deviation between the centers of the pupils and the centers of the half mirrors 261A and 262A functioning as the optical elements. The value may be an average of the left and the right or may be a value in the positions of the centers of the left and right eyes. That is, the value may be a value obtained by averaging deviation between the pupil center of the right eye of the user and the center of the half mirror 261A on the right side and deviation between the pupil center of the left eye of the user and the center of the half mirror 262A on the left side. Further, the value may be a value obtained by calculating deviation concerning the center positions of the pupils of the left and right eyes of the user and the center positions of the center of the half mirror 261A and the center of the half mirror 262A.

The control unit 140 calculates, on the basis of a picked-up image picked up by the second camera 62, deviation between the centers of the pupils and the centers of the half mirrors 261A and 262A and registers a calculation result in the user information table. In this processing, the centers of the pupils are represented by X and Y coordinate values of the center positions of the pupils in the picked-up image. The X coordinate indicates the horizontal direction of the picked-up image and the Y coordinate indicates the vertical direction of the picked-up image. The centers of the half mirrors 261A and 262A are represented by X and Y coordinate values of the center positions of the half mirrors 261A and 262A in the picked-up image. The control unit 140 calculates, for example, with reference to the center positions of the pupils, to which degree the center positions of the half mirrors 261A and 262A deviate in the direction of the X coordinate and the direction of the Y coordinate.

The angle of the optical elements is calculated on the basis of a measurement value of a nine-axis sensor 66. The angle of the optical elements is represented by a rotation angle (θr, θp, θy) of the half mirror 262A at the time when the image display unit 20 is worn on the head of the user. Note that, as the rotation angle (θr, θp, θy), for example, when the center of the half mirror 262A is set as the origin and a roll axis, a pitch axis, and a yaw axis orthogonal to one another at the origin are defined, an angle formed by the optical axis direction of the half mirror 262A and the roll axis is represented by a roll angle θr. An angle formed by the optical axis direction of the half mirror 262A and the pitch axis is represented by a pitch angle θp. An angle formed by the optical axis direction of the half mirror 262A and the yaw axis is represented by a yaw angle θy.

The brightness is information indicating brightness of an image displayed in a display region of the image display unit 20. The color information is information indicating whether the user has abnormality in color vision. The language in use is language information such as Japanese or English that the user uses.

The interface 125 is an interface for connecting various external apparatuses OA functioning as supply sources of contents to the control device 10. As the interface 125, interfaces adapted to wired connection such as a USB interface, a micro USB interface, and an interface for a memory card can be used.

A three-axis sensor 113, a GPS 115, a communication unit 117, and a sound recognition unit 114 are connected to the control unit 140. The three-axis sensor 113 is a three-axis acceleration sensor. The control unit 140 can acquire a detection value of the three-axis sensor 113. The GPS 115 includes an antenna (not shown in the figure), receives a GPS (global Positioning System) signal, and calculates a present position of the control device 10. The GPS 115 outputs the present position and present time calculated on the basis of the GPS signal to the control unit 140. The GPS 115 may include a function of acquiring the present time on the basis of information included in the GPS signal and causing the control unit 140 of the control device 10 to correct time clocked by the control unit 140.

The communication unit 117 executes radio data communication conforming to a standard such as a wireless LAN (WiFi (registered trademark)), Miracast (registered trademark), or Bluetooth (registered trademark).

When the external apparatus OA is connected to the communication unit 117 by radio, the control unit 140 performs control for acquiring content data from the communication unit 117 and displaying an image on the image display unit 20. On the other hand, when the external apparatus OA is connected to the interface 125 by wire, the control unit 140 performs control for acquiring content data from the interface 125 and displaying an image on the image display unit 20. Therefore, the communication unit 117 and the interface 125 are hereinafter collectively referred to as data acquiring unit DA.

The data acquiring unit DA acquires content data from the external apparatus OA. The data acquiring unit DA acquires, from the external apparatus OA, data of an image displayed by the head-mounted display device 100 (hereinafter referred to as “image display data”).

The sound recognition unit 114 extracts features from digital sound data collected by the microphone 63 and converted into digital data by the sound processing unit 187 explained below and models the features. The sound recognition unit 114 extracts and models features of sound to perform speaker recognition for separately recognizing voices of a plurality of people and specifying, for each of the voices, a speaking person and text conversion for converting the sound into a text. In the processing of the sound recognition, the sound recognition unit 114 may be capable of identifying a type of a language of the sound data.

The control unit 140 reads out and executes a computer program stored in the storing unit 120 to thereby function as an operating system (OS) 150, an image processing unit 160, a display control unit 170, a biological-information detecting unit 181, and a setting-information detecting unit 182. The control unit 140 functions as a setting unit 183, a target detecting unit 184, a position detecting unit 185, an information-display control unit 186, and the sound processing unit 187.

The image processing unit 160 acquires an image signal included in contents. The image processing unit 160 separates, from the acquired image signal, synchronization signals such as a vertical synchronization signal VSync and a horizontal synchronization signal HSync. The image processing unit 160 generates, according to a cycle of the separated vertical synchronization signal VSync and horizontal synchronization signal HSync, a clock signal PCLK using a PLL (Phase Locked Loop) circuit or the like (not shown in the figure). The image processing unit 160 converts an analog image signal, from which the synchronization signals are separated, into a digital image signal using an A/D conversion circuit or the like (not shown in the figure). The image processing unit 160 stores the digital image signal after the conversion in a DRAM in the storing unit 120 frame by frame as image data (in the figure, Data) of a target image. The image data is, for example, RGB data.

Note that the image processing unit 160 may execute, according to necessity, on the image data, image processing such as resolution conversion processing, various kinds of tone correction processing such as adjustment of luminance and chroma, and keystone correction processing.

The image processing unit 160 transmits each of the generated clock signal PCLK, the vertical synchronization signal VSync, the horizontal synchronization signal HSync, and the image data Data stored in the DRAM in the storing unit 120 via the transmitting unit 51 and 52. Note that the image data Data transmitted via the transmitting unit 51 is referred to as “image data for right eye” as well and the image data Data transmitted via the transmitting unit 52 is referred to as “image data for left eye” as well. The transmitting units 51 and 52 function as a transceiver for serial transmission between the control device 10 and the image display unit 20.

The display control unit 170 generates a control signal for controlling the right display driving unit 22 and the left display driving unit 24. Specifically, the display control unit 170 individually controls, according to the control signal, ON/OFF of driving of the right LCD 241 by a right LCD control unit 211 and ON/OFF of driving of a right backlight 221 by a right backlight control unit 201. The display control unit 170 individually controls ON/OF of driving of the left LCD 242 by a left LCD control unit 212 and ON/OFF of driving of the left backlight 222 by a left backlight control unit 202. Consequently, the display control unit 170 controls generation and emission of image light by each of the right display driving unit 22 and the left display driving unit 24. For example, the display control unit 170 controls the right display driving unit 22 and the left display driving unit 24 according to the control signal to cause both of the right display driving unit 22 and the left display driving unit 24 to generate image lights or cause one of the right display driving unit 22 and the left display driving unit 24 to generate image light. The display control unit 170 can also control the right display driving unit 22 and the left display driving unit 24 according to the control signal to not cause the right display driving unit 22 and the left display driving unit 24 to generate image lights.

The display control unit 170 transmits control signals to the right LCD control unit 211 and the left LCD control unit 212 respectively via the transmitting units 51 and 52. The display control unit 170 transmits control signals to the right backlight control unit 201 and the left backlight control unit 202 respectively via the transmitting units 51 and 52.

The biological-information detecting unit 181 functioning as the input unit has an information registration mode and a user specifying mode as operation modes. The information registration mode is a mode for detecting biological information and setting information of the user and registering the detected biological information and the detected setting information in the user information table. The user specifying mode is a mode for detecting biological information of the user and determining whether biological information coinciding with the detected biological information is registered in the user information table.

In the information registration mode, the biological-information detecting unit 181 extracts the biological information of the user from a picked-up image picked up by the first camera 61. In the information registration mode, the setting-information detecting unit 182 calculates setting information on the basis of a picked-up image picked up by the second camera 62 and a measurement value of the nine-axis sensor 66. Note that the biological information registered in the user information table in the information registration mode is referred to as registered biological information.

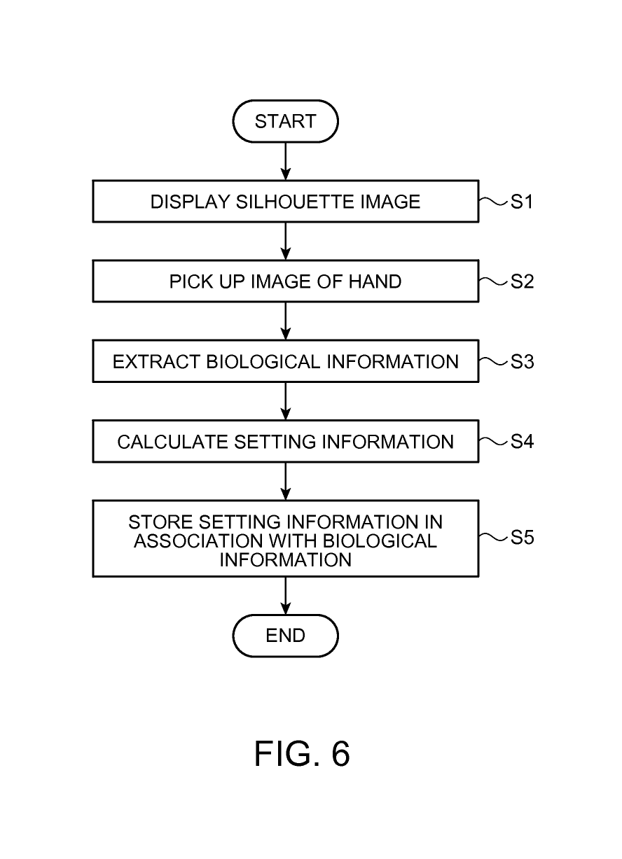

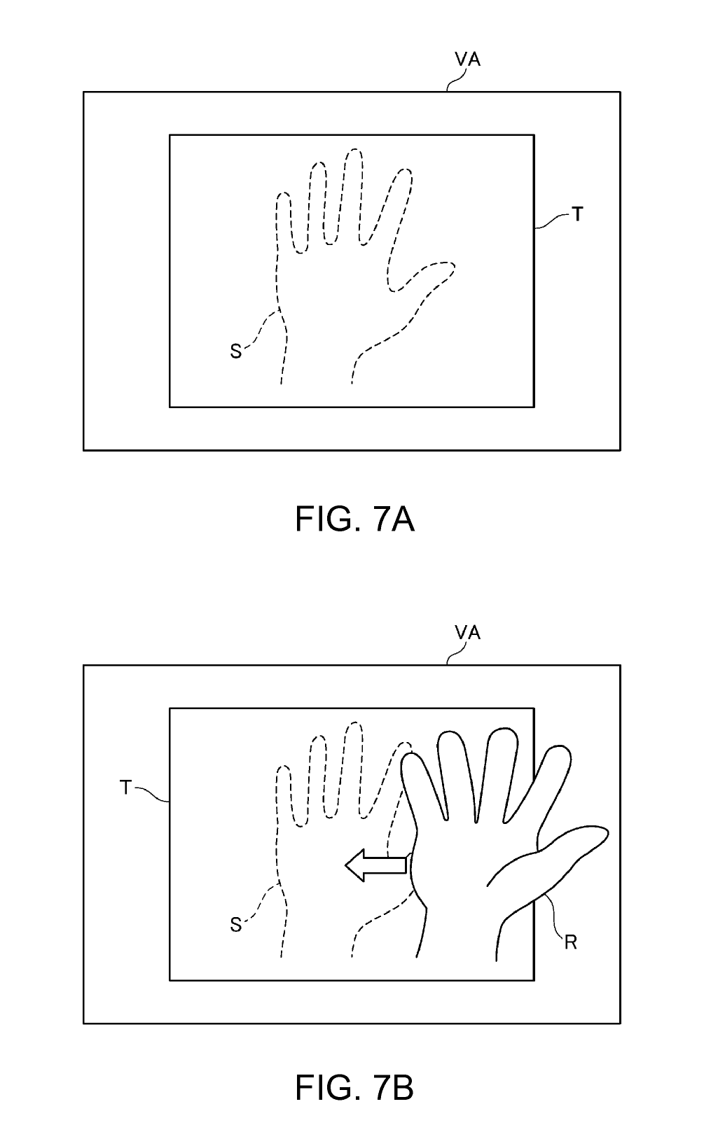

FIG. 6 is a flowchart for explaining the operation of the head-mounted display device 100 in the information registration mode. FIG. 6 shows, in particular, a processing procedure of the biological-information detecting unit 181 and the setting-information detecting unit 182. FIGS. 7A and 7B show an example of an image displayed by the head-mounted display device 100 in the information registration mode. FIG. 7A shows an example of a silhouette image S. FIG. 7B shows an example of adjustment performed using the silhouette image S.

In the information registration mode, the biological-information detecting unit 181 outputs an image of a shape of a hand (hereinafter referred to as silhouette image S) to the display control unit 170 and causes the image display unit 20 to display the silhouette image S (step S1). In FIG. 7A, the silhouette image S displayed by the image display unit 20 is shown. The image display unit 20 displays a visual field VA viewed by the user, a display region T where the image display unit 20 displays an image, and the silhouette image S displayed in the display region T. Note that the display region T of the image display unit 20 is a range in which the user can see images displayed by the right optical-image display unit 26 and the left optical-image display unit 28. The display region T is a maximum range in which the image display unit 20 causes the user to visually recognize an image. The image display unit 20 displays the image in the entire or a part of the display region T.

The user adjusts the position of the hand of the user to match the silhouette image S while visually recognizing the silhouette image S displayed on the image display unit 20. In FIG. 7B, a state in which the user performs adjustment of the position of a hand R of the user to match the silhouette image S displayed in the display region T is shown. After adjusting the position of the hand R, the user operates the operation unit 111 with the other hand and instructs image pickup of an image of the hand R. When the operation of the operation unit 111 is input, the biological-information detecting unit 181 causes the first camera 61 to pick up an image of the hand R of the user (step S2). The picked-up image picked up by the first camera 61 is input to the biological-information detecting unit 181.

The biological-information detecting unit 181 subjects the input picked-up image to image processing and extracts biological information (step S3). First, the biological-information detecting unit 181 gray-scales the picked-up image and applies edge detection to the picked-up image after the gray-scaling. The biological-information detecting unit 181 compares the shape of the detected edge and the contour shape of the silhouette image S and detects a region where the hand R of the user is shown (hereinafter, hand region). Note that, since the silhouette image S serving as a guide is displayed in a predetermined position of the display region T, the position of the hand R shown in the picked-up image picked up by the first camera 61 is substantially fixed. Therefore, the biological-information detecting unit 181 does not need to apply the edge detection to the entire picked-up image and only has to apply the edge detection to a region set beforehand.

The biological-information detecting unit 181 extracts biological information of the user from the picked-up image in the detected hand region of the user (step S3). The biological-information detecting unit 181 detects, from the picked-up image in the hand region, absolute length information of the hand, length ratio information of a finger, and palm line information as the biological information.

After detecting the biological information, the biological-information detecting unit 181 generates a user ID for identifying the user and registers the biological information in the user information table in associated with the generated user ID. A plurality of kinds of palm line information can be detected from the picked-up image of the hand. However, the biological-information detecting unit 181 does not have to register palm line information of all detectable palm lines in the user information table. The biological-information detecting unit 181 selects (curtails) a palm line out of palm lines detectable from the picked-up image and registers the palm line in the user information table. Note that, when not only the palm line information but also a plurality of kinds of biological information are obtained, the biological-information detecting unit 181 desirably performs the curtailing to reduce the number of palm lines registered in the user information table.

In the information registration mode, the setting-information detecting unit 182 calculates setting information of the user (step S4). The setting-information detecting unit 182 causes the second camera 62 to execute image pickup. An image of the face of the user and the half mirror 262A (see FIG. 2) is picked up by the second camera 62. The picked-up image picked up by the second camera 62 is input to the setting-information detecting unit 182. The setting-information detecting unit 182 calculates setting information on the basis of the picked-up image picked up by the second camera 62 (step S4). The setting-information detecting unit 182 calculates, as the setting information, an interocular distance of the user, an angle of convergence, a relative position of the pupils and the optical elements. The setting-information detecting unit 182 registers the calculated setting information in the user information table in association with relevant biological information of the user (step S5).

The setting-information detecting unit 182 calculates, on the basis of a measurement value of the nine-axis sensor 66, as the setting information, an angle of the optical elements at the time when the user wears the head-mounted display device 100 (step S4). The angle of the optical elements is represented by a rotation angle (θr, θp, θy) of the half mirror 262A at the time when the image display unit 20 is worn on the head of the user. The setting-information detecting unit 182 registers the calculated setting information in the user information table in association with relevant biological information of the user (step S5).

Besides, the setting-information detecting unit 182 registers setting information such as a dominant eye, brightness setting, color information, and a language in use input by the operation of the operation unit 111 by the user in the user information table in association with relevant biological information of the user.

For example, when adjusting the brightness of an image displayed by the image display unit 20, the setting-information detecting unit 182 controls the display control unit 170 and causes the image display unit 20 to display a test image for adjusting the brightness. The user operates the luminance switching key 15 of the operation unit 111 and inputs operation for increasing or reducing the brightness of the test image while visually recognizing the image displayed by the image display unit 20. The setting-information detecting unit 182 controls the display control unit 170 according to the operation input from the operation unit 111 and adjusts the brightness of the test image displayed by the image display unit 20. When receiving operation of the determination key 11, the setting-information detecting unit 182 causes the storing unit 120 to store the brightness of the test image displayed by the image display unit 20, that is, luminance information of the right backlight 221 and the left backlight 222.

The setting-information detecting unit 182 controls the display control unit 170, causes the image display unit 20 to display image data for urging an input of a language in use, and receives operation of the operation unit 111. For example, the setting-information detecting unit 182 controls the display control unit 170 and causes the image display unit 20 to display texts and/or images including messages “Is your dominant eye is the right eye?” and “A language in use is Japanese?”. The setting-information detecting unit 182 determines the dominant eye and the language in use of the user on the basis of operation received by the operation unit 111 and registers the document eye and the language in use in the user information table as setting information of a user ID corresponding to the user.

In the user specifying mode, the biological-information detecting unit 181 detects biological information of the user according to a procedure same as the procedure in the case of the biological information registration mode and passes the detected biological information to the setting unit 183. The setting unit 183 compares the biological information passed from the biological-information detecting unit 181 and the registered biological information registered in the user information table and determines whether the registered biological information coinciding with the biological information detected by the biological-information detecting unit 181 is registered in the user information table.

In the user specifying mode, the biological information is input to the setting unit 183 from the biological-information detecting unit 181.

The setting unit 183 performs collation processing for collating the biological information input to the setting unit 183 (hereinafter referred to as input biological information) and the registered biological information registered in the user information table and determining whether the registered biological information coinciding with the input biological information is registered in the user information table.

When performing the collation processing, the setting unit 183 performs curtailing processing for curtaining biological information used for the collation processing. The setting unit 183 applies the same curtailing processing to both of the input biological information and the registered biological information.

For example, in the user information table 120A and the palm line information table 120B shown in FIGS. 5A and 5B, the absolute length of the hand, the length ratio of the finger, the angle of the palm surface, and the palm line information are registered as the registered biological information. The setting unit 183 selects, out of the registered biological information, one or a plurality of kinds of biological information used for the collation processing. Concerning the input biological information, the setting unit 183 selects biological information same as the biological information selected from the registered biological information. The setting unit 183 performs collation processing of the selected input biological information and the selected registered biological information. For example, the setting unit 183 selects the palm line information and the length ratio of the finger out of the registered biological information registered in the user information table. Similarly, the setting unit 183 selects the palm line information and the length ratio of the finger out of the input biological information. The setting unit 183 compares the palm line information serving as the selected registered biological information and the palm line information serving as the selected input biological information and performs collation. Similarly, the setting unit 183 compares the length ratio of the finger serving as the selected registered biological information and the length ratio of the finger serving as the selected input biological information.

The setting unit 183 may reduce a load of the collation processing by curtaining feature information used for the collation processing rather than selecting the registered biological information used for the collation processing. For example, in the user information table shown in FIG. 4, a plurality of kinds of palm line information of the same user are registered as the palm line information. The setting unit 183 selects one or a plurality of kinds of palm line information used for the collation out of the plurality of kinds of palm line information registered in the user information table. The setting unit 183 selects, out of the input biological information, palm line information having coordinates closest to a start point coordinate and an end point coordinate of the selected palm line information and performs collation of these kinds of palm line information.

The setting unit 183 may curtail kinds of the feature information used for the collation to reduce the load of the collation processing.

For example, in the user information table shown in FIG. 5A, the start point coordinate and the end point coordinate, the length ratio, and the curvature are registered as the palm line information. The setting unit 183 selects one or a plurality of kinds of the palm line information used for the collation out of the plurality of kinds of palm line information registered in the user information table. For example, the selecting unit 183 selects the length ratio of the palm line out of the palm line information as the feature information used for the collation. After selecting the palm line information out of the input biological information, the setting unit 183 extracts, from the user information table, palm line information having coordinates closest to the start point coordinate and the end point coordinate of the selected palm line information. The setting information 183 compares the length ratio of the extracted palm line information and the length ratio of the palm line information selected from the input biological information and performs the collation.

Note that the curtailing processing performed by the setting unit 183 may be performed by selecting one of the curtaining of the biological information used for the collation processing, the curtaining of the feature information used for the collation processing, and the curtailing of the kinds of the feature info nation used for the collation processing. The curtailing processing performed by the setting unit 183 may be curtailing processing for performing the collation by combining the plurality of kinds of curtaining.

When determining according to the collation of the input biological information and the registered biological information that the input biological information coincides with the registered biological information registered in the user information table, the setting unit 183 reads out setting information corresponding to the coinciding biological information from the user information table. The setting unit 183 outputs the brightness setting registered in the setting information to the display control unit 170. The display control unit 170 adjusts, according to the brightness setting input from the setting unit 183, a light amount of the right backlight 221 and the left backlight 222 to a light amount corresponding to the brightness setting.

The setting unit 183 passes information concerning the dominant eye registered as the setting information to the display control unit 170. For example, when a three-dimensional (3D) image is displayed by the image display unit 20, when the operation unit 111 is operated and switching to a two-dimensional image is instructed, the display control unit 170 causes the image display unit 20 to display an image on a side of the dominant eye indicated by the dominant eye information. For example, when “left eye” is registered in the setting information as the dominant eye of the user, the display control unit 170 causes the image display unit 20 to display an image for left eye. Consequently, when the display is switched from a display state of the three-dimensional image to the two-dimensional image, it is possible to reduce a sense of discomfort involved in the switching of the display mode.

The setting unit 183 passes the color information and the language in use registered as the setting information to the information-display control unit 186. The information-display control unit 186 processes display data (explained below) and adds new display data on the basis of the color information and the language in use passed from the setting unit 183.

The setting unit 183 calculates, on the basis of at least one of an interocular distance, an angle of convergence, a relative distance of the eyes and the optical elements, and an angle of the optical elements, a correction coefficient for correcting a display position and/or a display size in the display region of the image display unit 20. The setting unit 183 passes the calculated correction coefficient to the position detecting unit 185.

The setting-information detecting unit 182 can also be determine, on the basis of the setting information measured by the user wearing the head-mounted display device 100, a segment to which the user belongs and register information indicating the determined segment in the user information table. In the storing unit 120, for each segment, information in which ranges of the interocular distance, ranges of the relative distance of the eyes and the optical elements, ranges of the angle of convergence, and ranges of the angle of the optical elements classified into segments are respectively set is stored. When the interocular distance, the angle of convergence, the relative distance of the eyes and the optical elements, and the angle of the optical elements are measured by the biological-information detecting unit 181, the setting-information detecting unit 182 determines, on the basis of the measured respective kinds of information, a segment to which the user belongs.

In the storing unit 120, correction coefficients corresponding to the segments are stored. After reading out information indicating a segment from the registered biological information corresponding to the input biological information, the setting unit 183 reads out, on the basis of the read-out information indicating the segment, a correction coefficient corresponding to the segment from the storing unit 120. The setting unit 183 outputs the read-out correction coefficient to the position detecting unit 185. Consequently, it is possible to change at least one of a display position and a display size of an image in a plurality of steps according to the setting information.

The target detecting unit 184 performs control for causing the first camera 61 to execute image pickup and acquires a picked-up image. The picked-up image is output from the first camera 61 as color image data or monochrome image data from the first camera 61. However, the first camera 61 may output an image signal and the target detecting unit 184 may generate image data matching a predetermined file format from the image signal.

The target detecting unit 184 analyzes the acquired picked-up image data and detects a target object shown in the picked-up image data. The target object is an object or a person present in an image pickup direction of the first camera 61, that is, a visual line direction of the user.

The position detecting unit 185 calculates, on the basis of the position of an image of the target object in the picked-up image picked up by the first camera 61, a relative position of a position where the user can see the target object and a position where the user can see an image displayed by the image display unit 20. For this processing, information indicating a positional relation between the display region of the image display unit 20 and the image pickup range (the angle of view) of the first camera 61 is necessary. Instead of the information, information indicating a positional relation between the visual field (the field of vision) of the user and the image pickup range (the angle of view) of the first camera 61 and information indicating a positional relation between the visual field (the field of vision) of the user and the display region of the image display unit 20 may be used. These kinds of information are stored in advance in, for example, the storing unit 120.

After detecting, concerning the image of the target object, the position with respect to the display region, the position detecting unit 185 corrects the position on the basis of the correction coefficient passed from the setting unit 183.

The position detecting unit 185 may detect a display size of the target object with respect to the display region together with the position of the target object.

After detecting, concerning the image of the target object, the display position and the display size with respect to the display region, the position detecting unit 185 corrects the detected display position and the detected display size on the basis of the correction coefficient passed from the setting unit 183. Consequently, when the user can see the image displayed by the image display unit 20 and the target object in the outside scene, it is possible to display the image in a predetermined state of the sizes of the display image sensed by the user and the image of the target object. Further, according to physical features of the user such as the interocular distance, the relative distance of the eyes and the optical elements, and the angle of the optical elements, it is possible to display the image in the predetermined state of the sizes of the display image sensed by the user and the image of the target object.

The information-display control unit 186 causes, on the basis of the processing results of the setting unit 183, the target detecting unit 184, and the position detecting unit 185, the image display unit 20 to display the display data. The head-mounted display device 100 may be configured to acquire, with the data acquiring unit DA, various data such as moving images, still images, characters, and signs. The head-mounted display device 100 can use these data as the display data.

The information-display control unit 186 determines, concerning the target object detected by the target detecting unit 184, a display position and a display size of the display data on the basis of, for example, the display position and/or the display size corrected by the position detecting unit 185 on the basis of the correction coefficient. For example, when the display data is text data, the information-display control unit 186 sets, for example, a display color, a font, and presence or absence of character decorations such as boldface and italic in addition to a display position and a display size of characters. For example, when the display data is image data, information-display control unit 186 sets a display color, transparency, and the like in addition to a display position and a display size of an image.

The information-display control unit 186 processes the image data on the basis of the color information and the language in use input from the setting unit 183. For example, when the input color information is color information indicating that the user has a green color anomaly, the information-display control unit 186 converts display data of green into another display color. The information-display control unit 186 outputs the converted display data to the display control unit 170 and causes the image display unit 20 to display the display data.

When English is set as the input language in use, the information-display control unit 186 translates text data serving as the display data into English and outputs the translated English text data to the display control unit 170 as the display data. The display data is displayed by the image display unit 20.

The sound processing unit 187 acquires a sound signal included in contents, amplifies the acquired sound signal, and supplies the sound signal to a speaker (not shown in the figure) in the right earphone 32 and a speaker (not shown in the figure) in the left earphone 34 connected to the coupling member 46. Note that, for example, when a Dolby (registered trademark) system is adopted, the sound signal is processed and different sounds with, for example, frequencies and the like varied are respectively output from the right earphone 32 and the left earphone 34.

The sound processing unit 187 acquires sound collected by the microphone 63, converts the sound into digital sound data, and performs processing related to the sound. For example, the sound processing unit 187 may extract features from the acquired sound and model the features to perform speaker recognition for separately recognizing voices of a plurality of people and specifying a speaking person for each of the voices.

The image display unit 20 includes the interface 25, the right display driving unit 22, the left display driving unit 24, the right light guide plate 261 functioning as the right optical-image display unit 26, and the left light guide plate 262 functioning as the left optical-image display unit 28. The image display unit 20 includes the first camera 61, the second camera 62, a vibration sensor 65, and the nine-axis sensor 66.

The vibration sensor 65 is configured using an acceleration sensor. As shown in FIG. 1, the vibration sensor 65 is disposed on the inside of the image display unit 20. In the example shown in FIG. 1, the vibration sensor 65 is incorporated in the vicinity of the end portion ER of the right optical-image display unit 26 in the right holding unit 21. When the user performs operation of knocking the end portion ER (knock operation), the vibration sensor 65 detects vibration due to the operation and outputs a detection result to the control unit 140. According to the detection result of the vibration sensor 65, the control unit 140 detects the knock operation by the user.

The nine-axis sensor 66 is a motion sensor that detects acceleration (three axes), angular velocity (three axes), and terrestrial magnetism (three axis). Since the nine-axis sensor 66 is provided in the image display unit 20, when the image display unit 20 is worn on the head of the user, the control unit 140 can detect movement of the head of the user on the basis of a detection value of the nine-axis sensor 66. Since the direction of the image display unit 20 is seen from the detected movement of the head of the user, the control unit 140 can estimate a visual line direction of the user.

An interface 25 includes a connector to which the right cord 42 and the left cord 44 are connected. The interface 25 outputs the clock signal PCLK, the vertical synchronization signal VSync, the horizontal synchronization signal HSync, and the image data Data, which are transmitted from the transmitting units 51 and 52, to receiving units (Rx) 53 and 54 corresponding thereto. The interface 25 outputs a control signal, which is transmitted from the display control unit 170, to the receiving units 53 and 54, the right backlight control unit 201, or the left backlight control unit 202 corresponding thereto.

The interface 25 is an interface of the first camera 61, the second camera 62, the vibration sensor 65, and the nine-axis sensor 66. A detection result of vibration by the vibration sensor 65 and a detection result of acceleration (three axes), angular velocity (three axes), and terrestrial magnetism (three axes) by the nine-axis sensor 66 are sent to the control unit 140 of the control device 10 via the interface 25.

The right display driving unit 22 includes the receiving unit 53, the right backlight (BL) control unit 201 and the right backlight (BL) 221 functioning as a light source, the right LCD control unit 211 and the right LCD 241 functioning as a display element, and the right projection optical system 251. The right backlight control unit 201 and the right backlight 221 function as the light source. The right LCD control unit 211 and the right LCD 241 function as the display element. Note that the right backlight control unit 201, the right LCD control unit 211, the right backlight 221, and the right LCD 241 are collectively referred to as “image-light generating unit” as well.

The receiving unit 53 functions as a receiver for serial transmission between the control device 10 and the image display unit 20. The right backlight control unit 201 drives the right backlight 221 on the basis of an input control signal. The right backlight 221 is, for example, a light emitting body such as an LED or an electroluminescent (EL) device. The right LCD control unit 211 drives the right LCD 241 on the basis of the clock signal PCLK, the vertical synchronization signal VSync, the horizontal synchronization signal HSync, and the image data for right eye Data input via the receiving unit 53. The right LCD 241 is a transmissive liquid crystal panel on which a plurality of pixels are arranged in a matrix shape.

The right projection optical system 251 is configured by a collimate lens that changes image light emitted from the right LCD 241 to light beams in a parallel state. The right light guide plate 261 functioning as the right optical-image display unit 26 guides the image light, which is output from the right projection optical system 251, to the right eye RE of the user while reflecting the image light along a predetermined optical path.

The left display driving unit 24 has a configuration same as the configuration of the right display driving unit 22. The left display driving unit 24 includes the receiving unit 54, the left backlight (BL) control unit 202 and the left backlight (BL) 222 functioning as a light source, the left LCD control unit 212 and the left LCD 242 functioning as a display element, and the left projection optical system 252. The left backlight control unit 202 and the left backlight 222 function as the light source. The left LCD control unit 212 and the left LCD 242 function as the display element. The left projection optical system 252 is configured by a collimate lens that changes the image light, which is emitted from the left LCD 242, to light beams in a parallel state. The left light guide plate 262 functioning as the left optical-image display unit 28 guides the image light, which is output from the left projection optical system 252, to the left eye LE of the user while reflecting the image light along a predetermined optical path.

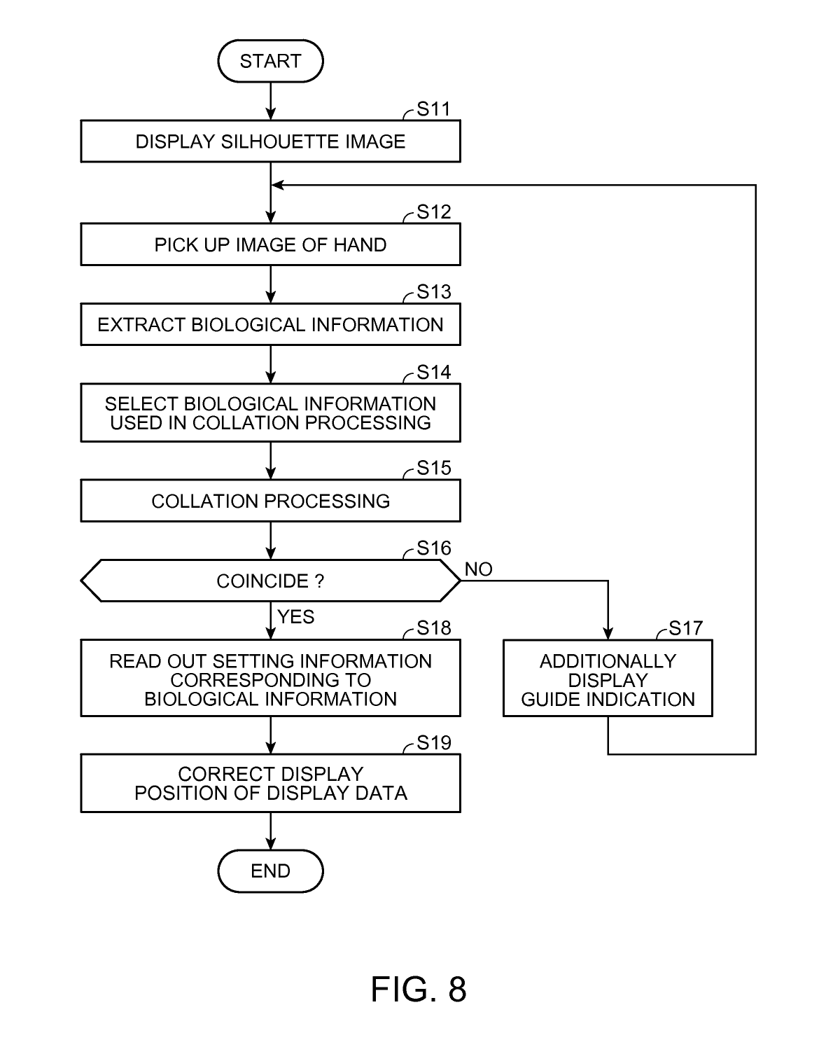

FIG. 8 is a flowchart for explaining the operation of the head-mounted display device 100 in registering user information.

Processing in step S11 of FIG. 8 is equivalent to the processing in step S1 explained in the flowchart of FIG. 6. Step S12 is equivalent to step S1 (FIG. 6). Step S13 is equivalent to step S3 (FIG. 6).

That is, in the information registration mode, the biological-information detecting unit 181 outputs the silhouette image S to the display control unit 170 and causes the image display unit 20 to display the silhouette image S (step S11). The user adjusts the position of the hand and operates the operation unit 111 while visually recognizing the silhouette image S and instructs image pickup of an image of the hand R. When the operation of the operation unit 111 is input, the biological-information detecting unit 181 causes the first camera 61 to pick up an image of the hand R of the user (step S12). The picked-up image picked up by the first camera 61 is input to the biological-information detecting unit 181. The biological-information detecting unit 181 subjects the picked-up image to image processing and extracts biological information (step S13).

In the user specifying mode, the biological information is input to the setting unit 183 from the biological-information detecting unit 181.

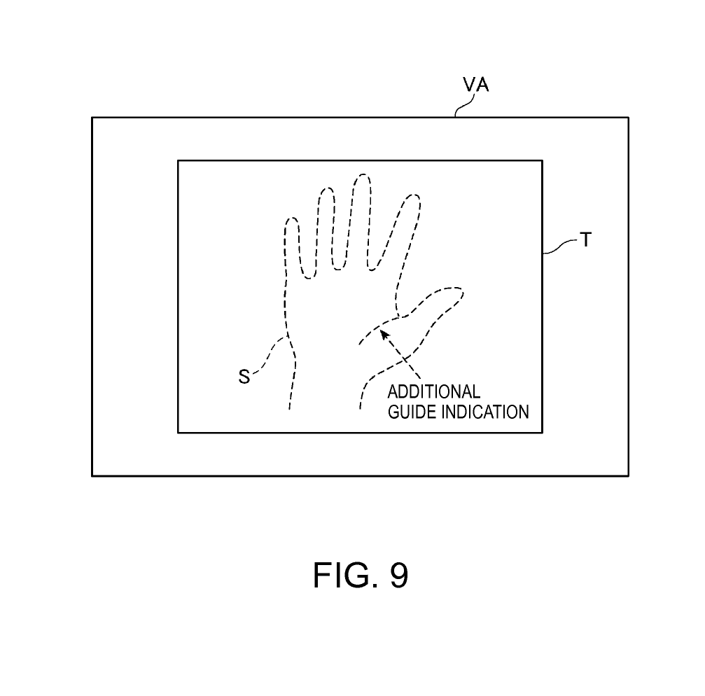

When the input biological information is input from the biological-information detecting unit 181, the setting unit 183 selects biological information used for collation processing (step S14). Note that, in this processing flow, the setting unit 183 performs the collation processing using palm line information. The setting unit 183 selects one or a plurality of kinds of palm line information used for collation out of a plurality of kinds of palm line information included in the input biological information. Consequently, the palm line information used for the collation is curtailed. After selecting the palm line information from the input biological information, the setting unit 183 reads out, from the user information table, palm line information having a coordinate closest to a start point coordinate and an end point coordinate of the selected palm line information and performs the collation processing (step S15). The setting unit 183 performs collation of a length ratio and/or a curvature of the palm line information extracted from the user information table and a length ratio and/or a curvature of the palm line information selected from the input biological information. The setting unit 183 performs the collation processing for all the kinds of selected palm line information (step S16). When it is determined by the collation processing that a degree of coincidence of the length ratios and/or the curvatures is lower than a threshold, that is, the length ratios and/or the curvatures do not coincide with each other (NO in step S16), the setting unit 183 causes the image display unit 20 to additionally display guide indication on the silhouette image S displayed by the image display unit 20 (step S17). The setting unit 183 adds a palm line of the palm line information determined as having a high degree of coincidence in the collation processing to the silhouette image S as additional guide indication (see FIG. 9).

FIG. 9 shows an example in which the palm line is added to the silhouette image S as the additional guide indication. In this example, a curved line is added and displayed as an additional guide on the silhouette image S displayed in the display region T. With the additional guide, operation for superimposing the hand R of the user on the silhouette image S is more easily performed. For example, depending on a distance or an angle between the first camera 61 and the hand, the degree of coincidence in the collation processing is low. Therefore, the setting unit 183 can improve collation accuracy of the collation processing by displaying the guide indication of the palm line on the silhouette image S. Note that the additional guide is not limited to the curved line equivalent to the palm line and may be a straight line or may include characters and other figures. In the operation for superimposing the hand on the silhouette image S, the additional guide only has to include information for guiding the position of the hand.

When it is determined by the collation processing that the degree of coincidence of the length ratios and/or the curvatures is higher than the threshold (YES in step S16), the setting unit 183 reads out setting information from the user information table (step S18). The setting information is setting information associated with registered biological information determined as having a high degree of coincidence with the input biological information. The setting unit 183 calculates, on the basis of the read-out setting information, a correction coefficient for correcting a display position or a display size of display data. The setting unit 183 calculates, on the basis of at least one of an interocular distance, an angle of convergence, a relative distance of the eyes and the optical elements, and an angle of the optical elements, the correction coefficient for correcting the display position or the display size of the display data. After calculating the correction coefficient, the setting unit 183 outputs the calculated correction coefficient to the position detecting unit 185.

The position detecting unit 185 detects, concerning an image of a target object detected from the picked-up image by the object detecting unit 184, a position and a size with respect to a display region. After detecting the position and the size with respect to the display region, the position detecting unit 185 corrects the detected position and the detected size on the basis of the correction coefficient passed from the setting unit 183 (step S19). The information-display control unit 186 determines, concerning the target object detected by the target detecting unit 184, a display position of the display data on the basis of, for example, the position and/or the size corrected by the position detecting unit 185 on the basis of the correction coefficient. Thereafter, the information-display control unit 186 outputs the display data to the display control unit 170 and causes the image display unit 20 to execute display.

Operation for transmitting and receiving contents of the user information table 120A and the palm line information table 120B in the communication system 1 is explained.

As a first communication form, there is a form in which the head-mounted display device 100A and the head-mounted display device 100B respectively transmit data to the server 5. The head-mounted display device 100A transmits the user information table 120A and the palm line information table 120B stored in the storing unit 120 to the server 5. The head-mounted display device 100B transmits the user information table 120A and the palm line information table 120B stored in the storing unit 120 to the server 5.

The server 5 stores data of the user information table 120A and the palm line information table 120B transmitted from the head-mounted display devices 100A and 100B. The server 5 can aggregate the tables transmitted from the head-mounted display devices 100A and 100B and configure the user information table of the display system 2.

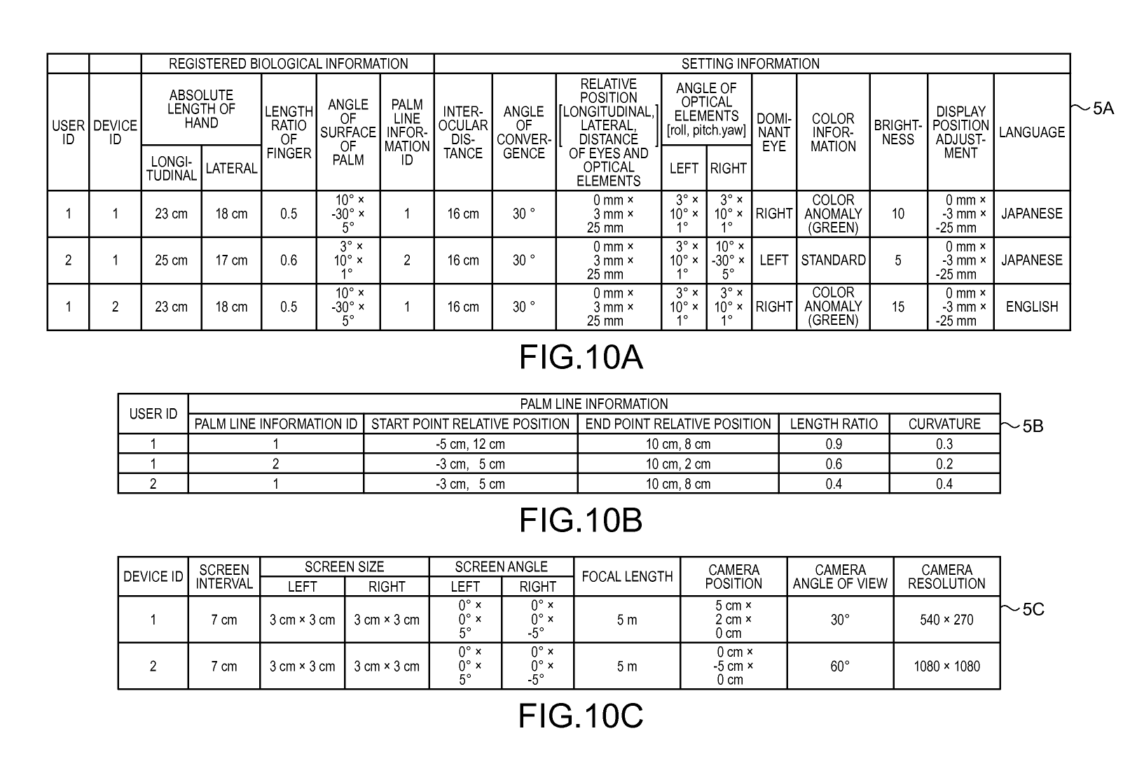

FIGS. 10A to 10C are schematic diagrams showing a configuration example of the user information table generated and stored by the server 5. FIG. 10A shows a user information table 5A, FIG. 10B shows a palm line information table 5B, and FIG. 10C shows a device information table 5C.

The user information table 5A is a table in which data of the storing unit 120 received from the head-mounted display devices 100A and 100B are aggregated. The palm line information table 5B is a table in which the palm line information table 120 received from the head-mounted display devices 100A and 100B are aggregated.

In the user information table 5A, a device ID is associated with the data of the user information table 120A shown in FIGS. 5A and 5B. Data in which the device ID is set to “1” in the user information table 5A is data transmitted to the server 5 by the head-mounted display device 100 to which the device ID “1” is given. Data in which the device ID is set to “2” is data transmitted to the server 5 by the head-mounted display device 100 to which a device ID “2” is given. The palm line information table 5B includes the data of the palm line information table 120B in association with the device ID.

In the example shown in FIGS. 10A and 10B, there are two data (records) in which the user ID is “1”. This indicates that one user registers biological information in each of the two head-mounted display devices 100A and 100B.

In this way, the server 5 receives the user information table 120A and the palm line information table 120B from the plurality of head-mounted display devices 100 and aggregates and stores the received data. Consequently, biological information and setting information registered in the head-mounted display devices 100 configuring the communication system 1 can be shared by all the head-mounted display devices 100. For example, the server 5 transmits the user information table 5A and the palm line information table 5B to the plurality of head-mounted display devices 100. Then, the head-mounted display device 100B can use biological information and setting information registered in the head-mounted display device 100A. That is, if the user performs registration in any one head-mounted display device 100, the user can realize registered setting in the other head-mounted display devices 100 on the basis of setting information of the user. Therefore, when a plurality of users use one head-mounted display device 100 and when one user uses the plurality of head-mounted display devices 100, it is possible to realize setting suitable for a user set in advance on the basis of biological information.

The server 5 may include the device information table 5C. The device information table 5C stores data concerning specifications of each of the head-mounted display devices 100 in association with the device ID. According to the device information table 5C, concerning the plurality of head-mounted display devices 100 included in the communication system 1, it is possible to specify a difference of specifications of the respective head-mounted display devices 100. For example, when the server 5 transmits the user information table 5A including setting information registered in the head-mounted display device 100B to the head-mounted display device 100A, the server 5 can convert values of the user information table 5A on the basis of the device information table 5C. In this case, a state same as setting of the head-mounted display device 100B can be realized in the head-mounted display device 100A taking into account a difference between the specifications of the head-mounted display device 100B and the head-mounted display device 100A. For example, the server 5 may transmit the device information table 5C to both of the head-mounted display devices 100A and 100B. The head-mounted display devices 100A and 100B may execute the conversion explained above. Consequently, even if there is a difference in the specifications of the head-mounted display devices 100 included in the communication system 1, it is possible to realize a setting state adjusted to the user in the respective head-mounted display devices 100.

As a second communication form, there is a form in which data is transmitted from the head-mounted display device 100A to the head-mounted display device 100B or from the head-mounted display device 100B to the head-mounted display device 100A. In this case, the head-mounted display devices 100A and 100B may directly communicate with each other or communicate via the radio access point 3, generate the user information table 5A and the palm line information table 5B, and store the user information table 5A and the palm line information table 5B in the storing unit 120. In this case as well, there is an advantage that the plurality of head-mounted display devices 100 included in the communication system 1 can share registered biological information and setting information.

As explained above, the head-mounted display device 100 in the first embodiment applied with the invention includes the storing unit 120, the first camera 61 and the biological-information detecting unit 181 functioning as the input unit, and the information-display control unit 186. The storing unit 120 stores the setting information concerning the display of the image display unit 20 in association with the identification information for identifying the user. The first camera 61 functioning as the input unit picks up an image of the hand of the user. The biological-information detecting unit 181 functioning as the input unit extracts biological information from the picked-up image. The information-display control unit 186 controls the display of the image display unit 20 on the basis of setting information corresponding to the input biological information. Consequently, it is possible to quickly perform, on the basis of the setting information, concerning display of the head-mounted display device 100, setting adjusted to the user.

The user information table 120A stored by the storing unit 120 includes a part of features included in the biological information of the user. It is possible to identify the user using the biological information. Since a part of the features included in the biological information is included, it is possible to perform simple setting corresponding to physical features.

The information-display control unit 186 collates a part of the biological information input as the identification information by the first camera 61 and the biological-information detecting unit 181 and a part of the features of the biological information stored as the identification information by the storing unit 120 and specifies setting information. Therefore, it is possible to perform simple setting corresponding to physical features.

The image display unit 20 transmits an outside scene and displays an image to be visually recognizable together with the outside scene. The information-display control unit 186 changes at least one of a display position and a display size of the image in a plurality of steps according to the setting information. Therefore, it is possible to set the display position and the display size of the image in the image display unit 20 stepwise according to the user.

The image display unit 20 includes the right light guide plate 261 and the left light guide plate 262 that transmit an outside scene and make image light incident on the eyes of the user to be visually recognizable together with the outside scene. The control unit 140 includes the target detecting unit 184 that detects a target object in a visual line direction of the user and the position detecting unit 185 that detects the position of the target object with respect to the display region of the image display unit 20. The information-display control unit 186 changes a display position of an image by the optical elements according to the position of the target object detected by the position detecting unit 185 and a positional relation between the right light guide plate 261 and the left light guide plate 262 and the positions of the pupils of the user. Therefore, it is possible to set the display position of the image according to the user.

The registration information of the user information table 120A includes, as setting information, information concerning setting of a language. When causing the image display unit 20 to display contents including characters, the information-display control unit 186 causes the image display unit 20 to display characters of a language corresponding to the setting information. Therefore, it is possible to set, according to the user, a language of characters displayed on the image display unit 20.

The head-mounted display device 100 includes the communication unit 117. The information-display control unit 186 transmits the user information table 120A and the palm line information table 120B stored in the storing unit 120 to the server 5. The head-mounted display device 100 may receive the user information table 5A and the palm line information table 5B in the communication unit 117 and store the user information table 5A and the palm line information table 5B in the storing unit 120. In this case, the head-mounted display device 100 can share the user information table 120A and the palm line information table 120B with the other head-mounted display devices 100. It is possible to perform, on the basis of the user information table 5A and the palm line information table 5B including information registered in the other devices, setting of display adjusted to the user.

### Second Embodiment

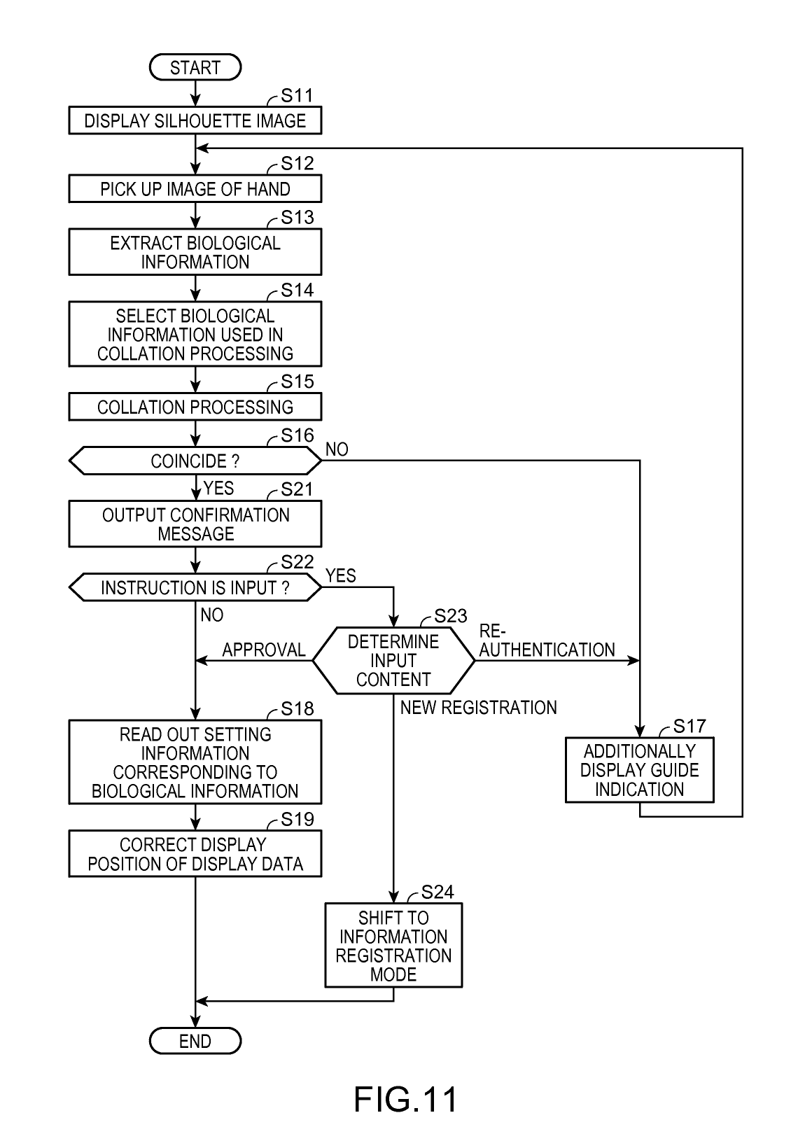

FIG. 11 is a flowchart for explaining the operation of the head-mounted display device 100 in a second embodiment applied with the invention. In the second embodiment, operation for seeking confirmation of a user when the head-mounted display device 100 succeeds in authentication performed using biological information (palm line information) is explained.

The configuration of the head-mounted display device 100 in the second embodiment is common to the first embodiment. Therefore, common components are denoted by the same reference numerals and signs and illustration and explanation of the components are omitted. In the flowchart of FIG. 11, processing common to the operation shown in FIG. 8 is denoted by the same step numbers and explanation of the processing is omitted.

In the second embodiment, an example is explained in which the setting unit 183 performs collation processing using palm line information in the user specifying mode.

The setting unit 183 selects one or a plurality of kinds of palm line information used for collation out of a plurality of kinds of palm line information included in the input biological information, reads out, from the user information table, palm line information having a coordinate closest to a start point coordinate and an end point coordinate of the selected palm line information, and performs the collation processing (step S15). The setting unit 183 performs collation of a length ratio and/or a curvature of the palm line information extracted from the user information table and a length ratio and/or a curvature of the palm line information selected from the input biological information. The setting unit 183 performs the collation processing for all the kinds of selected palm line information (step S16).

When it is determined by the collation processing that the length ratios and/or the curvatures do not coincide with each other (NO in step S16), the setting unit 183 causes the image display unit 20 to additionally display guide indication on the silhouette image S displayed by the image display unit 20 (step S17) and returns to step S12.

On the other hand, when it is determined by the collation processing that the degree of coincidence of the length ratios and/or the curvatures is higher than the threshold, the setting unit 183 determines that the kinds of palm line information coincide with each other (YES in step S16). In this case, the setting unit 183 acquires a user ID from setting information associated with registered biological information determined as having a high degree of coincidence with the input biological information in the user information table 120A and outputs a confirmation message on the basis of the acquired user ID (step S21). Content of the confirmation message is a message for confirming that setting corresponding to the user ID having the coinciding palm line information is performed. The output of the message is performed by, for example, display of a text or an image by the image display unit 20 and/or a sound output from the right ear phone 32 and the left ear phone 34. A specific example of the message may be set as “ID: setting of 1 is used” or the like using the user ID. A user name corresponding to the user ID may be registered in the user information table 120A. In this case, the user name can be included in the message output in step S21.

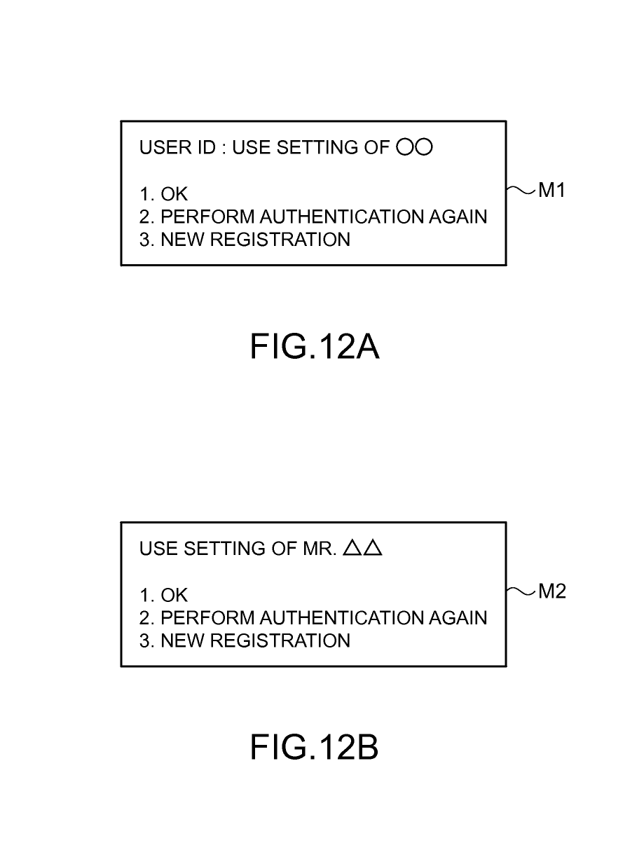

A message for requesting the user to input an instruction can be included in the message output in step S21. FIGS. 12A and 12B show, as an example of the message output by the head-mounted display device 100, examples of messages displayed on the image display unit 20.

A message M1 shown in FIG. 12A includes content for presenting the user ID and requesting the user to input an instruction to perform setting. In the message M1, as choices of the instruction input, three kinds of instruction inputs are possible: 1. instruct approval, 2. instruct to perform authentication again, and 3. instruct new registration of palm line information.

A message M2 shown in FIG. 12B includes content for presenting a user name corresponding to the user ID and requesting the user to input an instruction. In the message M2, the three kinds of instruction inputs are requested as in the message M1. The setting unit 183 outputs the messages M1 and M2 by, for example, displaying the messages M1 and M2 on the image display unit 20.

After outputting the message including the content for requesting or urging an instruction input like the message M1 or M2, the setting unit 183 stands by for input operation by the user within a predetermined time and determines presence or absence of the input operation (step S22). After outputting the message, when determining that the input operation is not performed within the predetermined time (No in step S22), the setting unit 183 shifts to step S18.

As explained with reference to FIG. 8, in step S18, the setting unit 183 reads out setting information from the user information table (step S18). The setting information is setting information associated with registered biological information determined as having a high degree of coincidence with the input biological information and is setting information corresponding to the user ID referred to when the confirmation message is output in step S21.

The setting unit 183 calculates, on the basis of the read-out setting information, a correction coefficient for correcting a display position or a display size of image data. The setting unit 183 calculates, on the basis of at least one of the interocular distance, the angle of convergence, the relative distance of the eyes and the optical elements, and the angle of the optical elements, a correction coefficient for correcting a display position and/or a display size of the image data. After calculating the correction coefficient, the setting unit 183 outputs the calculated correction coefficient to the position detecting unit 185.

The position detecting unit 185 detects, concerning the image of the target object detected from the picked-up image by the target detecting unit 184, a position and a size with respect to the display region. After detecting the position and the size with respect to the display region, the position detecting unit 185 corrects the detected position and the detected size on the basis of the correction coefficient passed from the setting unit 183 (step S19). The information-display control unit 186 determines, concerning the target object detected by the target detecting unit 184, a display position of the display data on the basis of, for example, the position and/or the size corrected by the position detecting unit 185 on the basis of the correction coefficient. Thereafter, the information-display control unit 186 outputs the display data to the display control unit 170 and causes the image display unit 20 to execute display.

On the other hand, when determining that the input operation is performed within the predetermined time after the confirmation message is output (YES in step S22), the setting unit 183 determines content of the input operation (step S23). As shown in FIGS. 12A and 12B, it is assumed that it is possible to perform the three kinds of instructions (the instruction for approval, the instruction for re-authentication, and the instruction for new registration) concerning the setting. When determining in step S23 that the input operation instructing approval is performed, the setting unit 183 shifts to step S18. When determining in step S23 that the input operation instructing re-authentication is performed, the setting unit 183 shifts to step S17.

When determining in step S23 that the input operation instructing new registration is performed, the setting unit 183 shifts to the information registration mode (step S24) and executes the operation shown in FIG. 6.

In the operation in the second embodiment shown in FIG. 11, the input operation performed by the user may be touch operation on the track pad 14. Voice of the user may be collected by the microphone 63 and recognized by the sound processing unit 187 to enable the user to perform an input by sound. The user may move a body part such as a finger, a hand, an arm, or a foot and the control unit 140 may detect the movement as a gesture on the basis of picked-up images of the first camera 61 and the second camera 62 to enable the user to perform a gesture input. In this way, the input by operation of the control device 10, the sound input, and the gesture input to the head-mounted display device 100 are possible. These inputs can be adopted not only in the first and second embodiments but also in embodiments explained below.

As explained above, it is possible to improve usability by outputting the confirmation message to the user before executing the setting on the basis of the result of the collation performed using the biological information such as the palm line. That is, by simplifying the biological information, even if it is likely that a collation result unintended by the user is obtained, the user can appropriately cope with the collation result. Even if a collation result coincides with a fact, when the user desires re-registration of biological information, the user can easily shift to operation for new registration. Consequently, the user can use the head-mounted display device 100 as intended by the user. It is possible to improve convenience.

### Third Embodiment

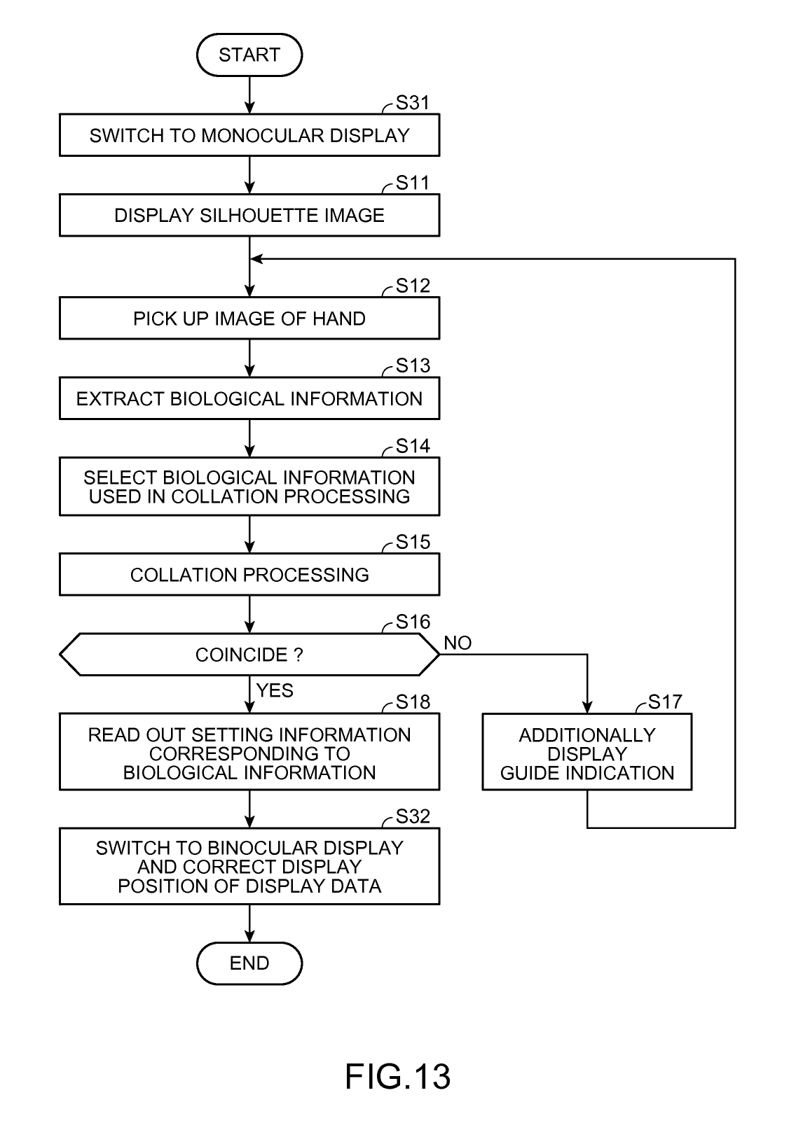

FIG. 13 is a flowchart for explaining the operation of the head-mounted display device 100 in a third embodiment applied with the invention. In the third embodiment, operation for performing monocular display as display in the image display unit 20 before setting based on setting information corresponding to a collation result of biological information (palm line information) is performed is explained.

The configuration of the head-mounted display device 100 in the third embodiment is common to the first embodiment. Therefore, common components are denoted by the same reference numerals and signs and illustration and explanation of the components are omitted. In the flowchart of FIG. 13, processing common to the operation shown in FIG. 8 is denoted by the same step numbers and explanation of the processing is omitted.

In the third embodiment, an example is explained in which the setting unit 183 performs collation processing using palm line information in the user specifying mode.

After starting operation in the user specifying mode, in step S11, the setting unit 183 switches the display of the image display unit 20 to the monocular display before operation for causing the image display unit 20 to display the silhouette image S in step S11 (step S31). The setting unit 183 controls the image processing unit 160 and/or the display control unit 170 and stops display by one of the right display driving unit 22 and the left display driving unit 24.

The stop of the display indicates a state in which the display by the right display driving unit 22 or the left display driving unit 24 is not visually recognized by a user. The stop of the display may include control for changing display of one of the right LCD 241 and the left LCD 242 to black or a predetermined color set in advance in an entire display region. The stop of the display may include control for extinguishing one of the right backlight 221 and the left backlight 222. The stop of the display may include control by the display control unit 170 for stopping transmission of the image data Data by one of the transmitting units 51 and 52. If any one of the controls is executed, a display image of one of the right display driving unit 22 and the left display driving unit 24 is not visually recognized.

Display of which of the right display driving unit 22 and the left display driving unit 24 is stopped may be set in advance or may be selected by the user.

In this way, a state in which the display of one of the right display driving unit 22 and the left display driving unit 24 is stopped can be considered a state of monocular (one eye) display in which the user visually recognizes a display image with one eye. On the other hand, a state in which both of the right display driving unit 22 and the left display driving unit 24 are not stopped can be considered a state of binocular (both eye) display in which the user visually recognizes a display image with both the eyes. The image display unit 20 can switch and execute the monocular display and the binocular display according to the control by the control unit 140.

After switching the display state in the image display unit 20 to the monocular display, the setting unit 183 executes the operation in steps S11 to S18 explained with reference to FIG. 8.

After reading out the setting information from the user information table 120A in step S18, the setting unit 183 corrects a display position and switches the display state to the binocular display (both eye display) according to the read-out setting information (step S32). The setting unit 183 starts display for the right display driving unit 22 or the left display driving unit 24 for which the display is stopped in step S31 and switches the image display unit 20 to the binocular display. Timing for the switching to the binocular display is not limited as long as the timing is after the setting information is read out from the user information table 120A. However, as explained below, the timing is desirably after a display position is corrected according to the read-out setting information. When the setting information includes attributes of display other than the display position or information concerning setting items, it is more desirable to switch the display state to the binocular display after not only the correction of the display position but also correction of the display based on these kinds of information is performed.

Before starting the binocular display, the setting unit 183 calculates, on the basis of the setting information read out from the user information table 120A, a correction coefficient for correcting a display position or a display size of image data and outputs the calculated correction coefficient to the display detecting unit 185. Details of processing for calculating the correction coefficient are the same as the processing in step S19 (FIG. 8) explained above. The position detecting unit 185 detects, concerning an image of a target object detected from the picked-up image by the target detecting unit 184, a position and a size with respect to the display region. After detecting the position and the size with respect to the display region, the position detecting unit 185 corrects the detected position and the detected size on the basis of the correction coefficient passed from the setting unit 183. The information-display control unit 186 determines, concerning the target object detected by the target detecting unit 184, a display position of the display data on the basis of, for example, the position and/or the size corrected by the position detecting unit 185 on the basis of the correction coefficient.

The control unit 140 may execute first whichever of the processing for determining a display position of the display data and the processing for switching the display state in the image display unit 20 from the monocular display to the binocular display. It is desirable to execute first the processing for determining a display position and thereafter switch the display of the image display unit 20 to the binocular display because the binocular display can be started in a preferred position.

As explained above, in the user specifying mode, the setting information is read out from the user information table 120A on the basis of the biological information and the display state of the image display unit 20 is changed to the monocular display before the display reflecting the setting information is performed. Consequently, it is possible to reduce a sense of discomfort of the user. That is, if a display position and the like are corrected according to the setting information of the user information table 120A, it is possible to realize a display state suitable for the user. However, before the correction is performed, it is likely that the display position and the like do not match the user. When this mismatching of the display position is large, it is likely that the user feels a sense of discomfort before the display position is corrected according to the setting information. In particular, when an image is displayed to be visually recognized by both the eyes of the user, the sense of discomfort is large unless parameters related to binocular vision such as an interocular distance (an inter-pupil distance) and an angle of convergence do not match the user. In this third embodiment, the monocular display is performed before the setting information is reflected on the display in the image display unit 20. That is, since the monocular display is performed before it is likely that the mismatching of the display position occurs, it is possible to suppress a sense of discomfort due to the mismatching.

### Fourth Embodiment

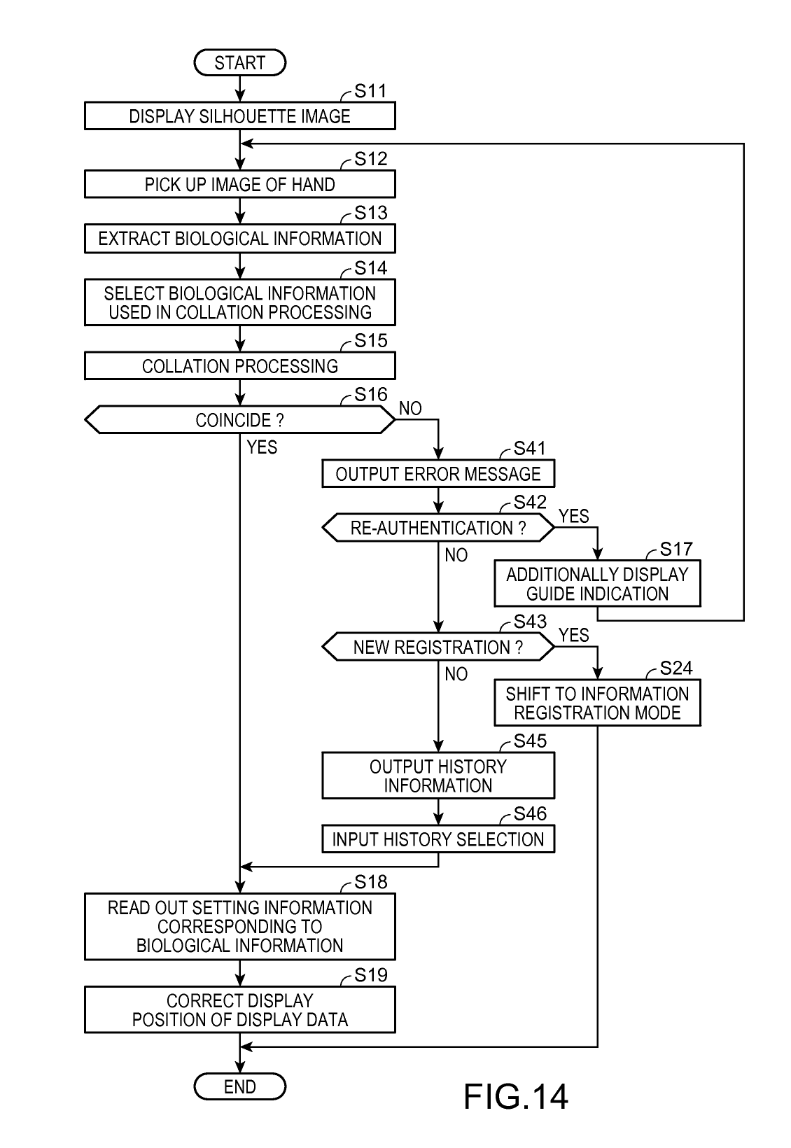

FIG. 14 is a flowchart for explaining the operation of the head-mounted display device 100 in a fourth embodiment applied with the invention. In the fourth embodiment, an example is explained in which, when the head-mounted display device 100 fails in collation of biological information (palm line information), the head-mounted display device 100 executes new registration or the like according to input operation by a user.

The configuration of the head-mounted display device 100 in the fourth embodiment is common to the first embodiment. Therefore, common components are denoted by the same reference numerals and signs and illustration and explanation of the components are omitted. In the flowchart of FIG. 14, processing common to the operation shown in FIG. 8 is denoted by the same step numbers and explanation of the processing is omitted.

In the fourth embodiment, an example is explained in which the setting unit 183 performs collation processing using palm line information in the user specifying mode. Operation in steps S11 to S16 is the same as the operation explained with reference to FIG. 8.

In step S15, the setting unit 183 selects one or a plurality of kinds of palm line information used for collation out of a plurality of kinds of palm line information included in the input biological information, reads out, from the user information table, palm line information having a coordinate closest to a start point coordinate and an end point coordinate of the selected palm line information, and performs the collation processing. In step S16, the setting unit 183 determines whether the kinds of palm line information coincide with each other in the collation processing.

When it is determined by the collation processing that the kinds of palm line information coincide with each other (YES in step S16), as in the operation explained with reference to FIG. 8, the setting unit 183 executes the processing in steps S18 and S19.

On the other hand, when it is determined by the collation processing that the kinds of palm line information do not coincide with each other (NO in step S16), the setting unit 183 outputs an error message (step S24). Content of the error message includes a message indicating that the kinds of palm line information do not coincide with each other in the collation and a message for requesting the user to input an instruction concerning operation to be performed thereafter. The output of the error message is performed by, for example, display of a text or an image by the image display unit 20 and/or a sound output from the right earphone 32 and the left earphone 34.

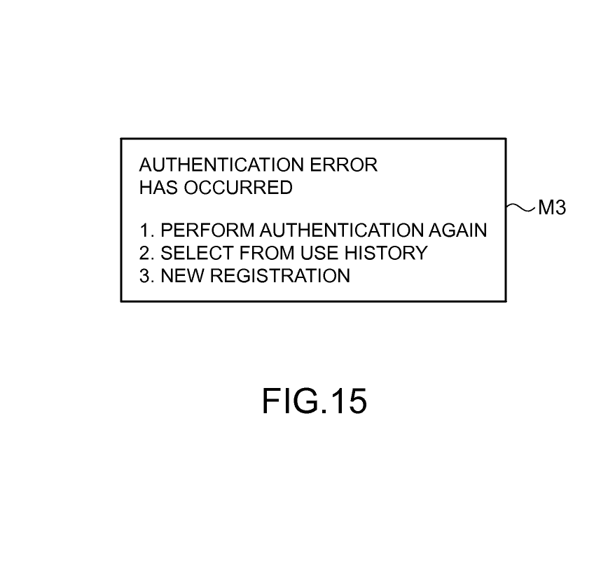

FIG. 15 illustrates an error message M3 displayed on the image display unit 20 as an example of a message output by the head-mounted display device 100. The error message M3 includes a text indicating that an authentication error occurs. In the error message M3, as choices of the instruction input, three kinds of instruction inputs are possible: 1. instruct to perform authentication again, 2. select from a use history, and 3. instruct new registration of palm line information.

After outputting the error message M3, the setting unit 183 stands by for input operation by the user within a predetermined time. When the input operation is performed, the setting unit 183 determines whether the input operation is the instruction for re-authentication (step S42). When determining that the input operation is the input operation for instructing re-authentication (YES in step S42), the setting unit 183 shifts to step S17.

On the other hand, when determining that the input operation is not the instruction for re-authentication (NO in step S42), the setting unit 183 determines whether the input operation is the instruction for new registration (step S43). When determining that the input operation is the instruction for new registration (YES in step S43), the setting unit 183 shifts to the information registration mode (step S24) and executes the operation in FIG. 6.

Therefore, when the user fails in the authentication performed using the biological information and cannot be specified, the user can select whether the authentication is performed again or new biological information is registered and cause the head-mounted display device 100 to execute the operation.

Further, when determining that the input operation is not the instruction for new registration (NO in step S43), the setting unit 183 determines that the input operation is instruction for selecting the user from history information and outputs the history information (step S45). The history information is a history of users who used the head-mounted display device 100 and is, for example, a history of user IDs of users who acquired the setting information from the user information table 120A. For example, every time setting information is acquired from the user information table 120A in step S18, the head-mounted display device 100 stores a user ID corresponding to the acquired setting information in the storing unit 120 or a RAM (not shown in the figure) of the control unit 140 as the history information. When user names are registered in the user information table 120A in association with the user IDs, the setting unit 183 may store the user names as the history information. The history information may be added every time the setting unit 183 reads out setting information from the user information table 120A. An upper limit may be provided for the number of kinds of history information stored in the storing unit 120 or the RAM (not shown in the figure). In step S45, the setting unit 183 outputs the history information stored in the storing unit 120 or the RAM through display by the image display unit 20 or a sound output from the right earphone 32 and the left earphone 34. The output history information may be a part of the history information stored in the storing unit 120 or the RAM. For example, kinds of history information may be selected and output by a number set in advance in order from the latest history information on the basis of dates and times of storage of the history information.

Thereafter, the setting unit 183 stands by for input operation by the user. When input operation for selecting any one of the output kinds of history information is performed (step S46), the setting unit 183 shifts to step S18 and reads out, from the user information table 120A, setting information corresponding to a user ID, which is the selected history information.

In this way, even when the head-mounted display device 100 fails in the collation performed using the biological information such as a palm line in the user specifying mode, the head-mounted display device 100 can specify a user on the basis of input operation of users using results of specifying users in the past and adjust a display position and the like. Therefore, even when the collation of the biological information is hindered, a legitimate user can use the head-mounted display device 100. It is possible to improve usability.

When the history information is output, date and time and a season when the history information is stored may be output in association with the user ID or the like serving as the history information. In this case, the user can select setting information used for the setting of the head-mounted display device 100 with reference to the date and time and the season. Position information detected by the GPS 115 may be stored in the storing unit 120 in association with the history information. In this case, when the history information is output, the position information may be output in association with the history information. The user can select the history information on the basis of a place where the history information is used in the past.

### Fifth Embodiment

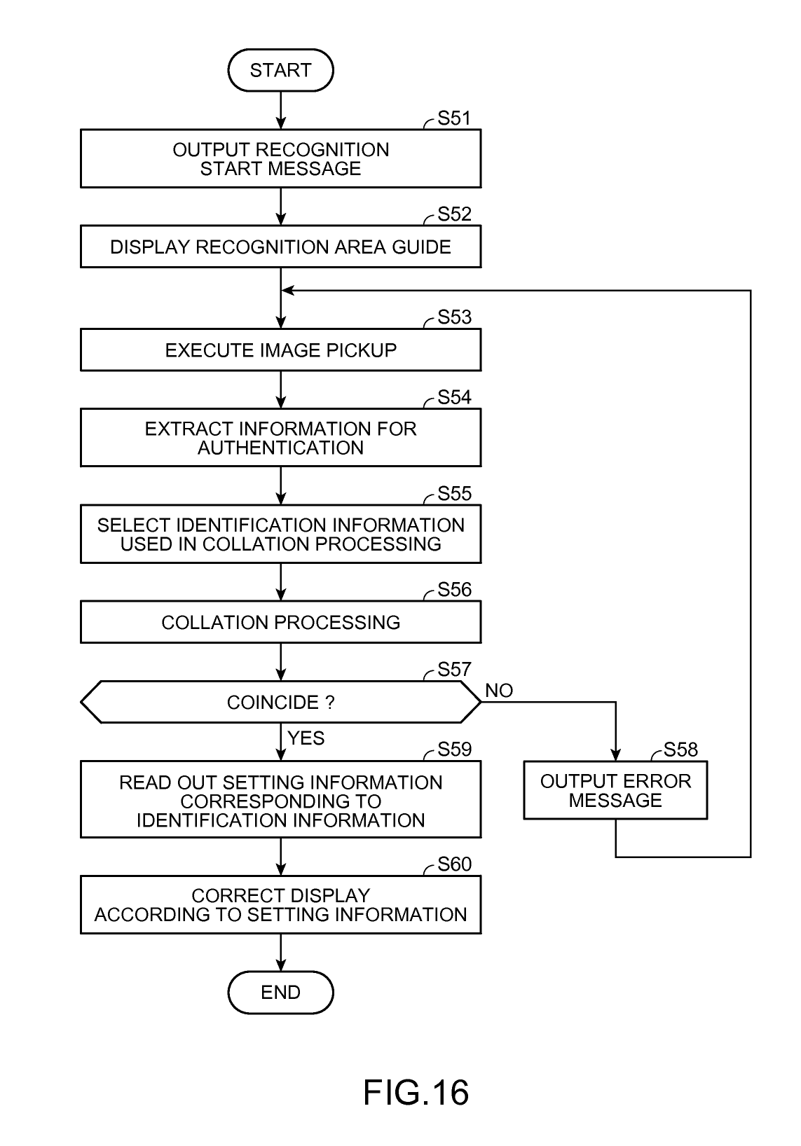

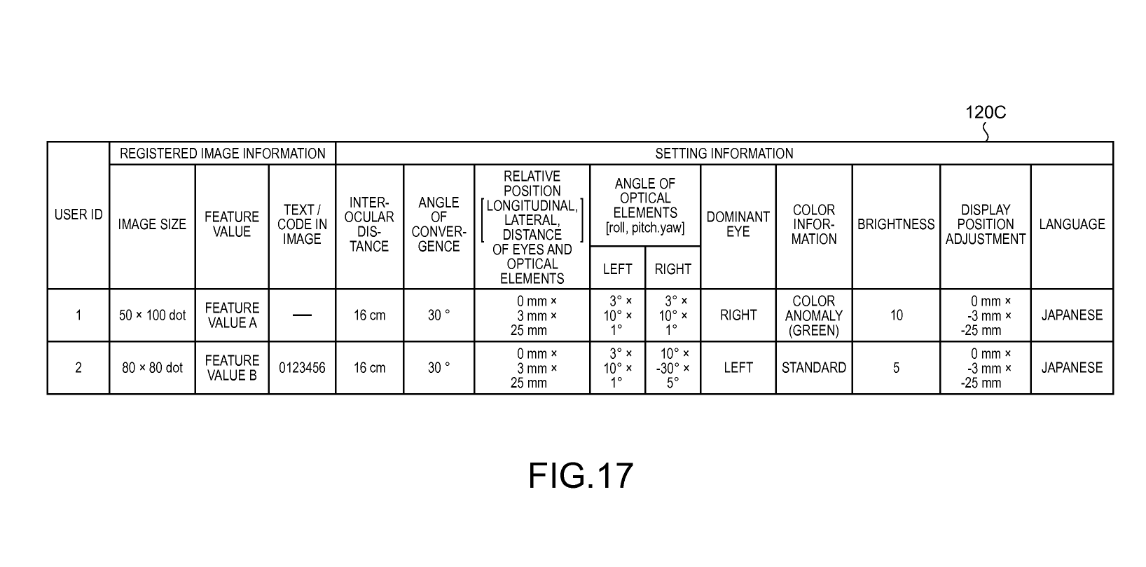

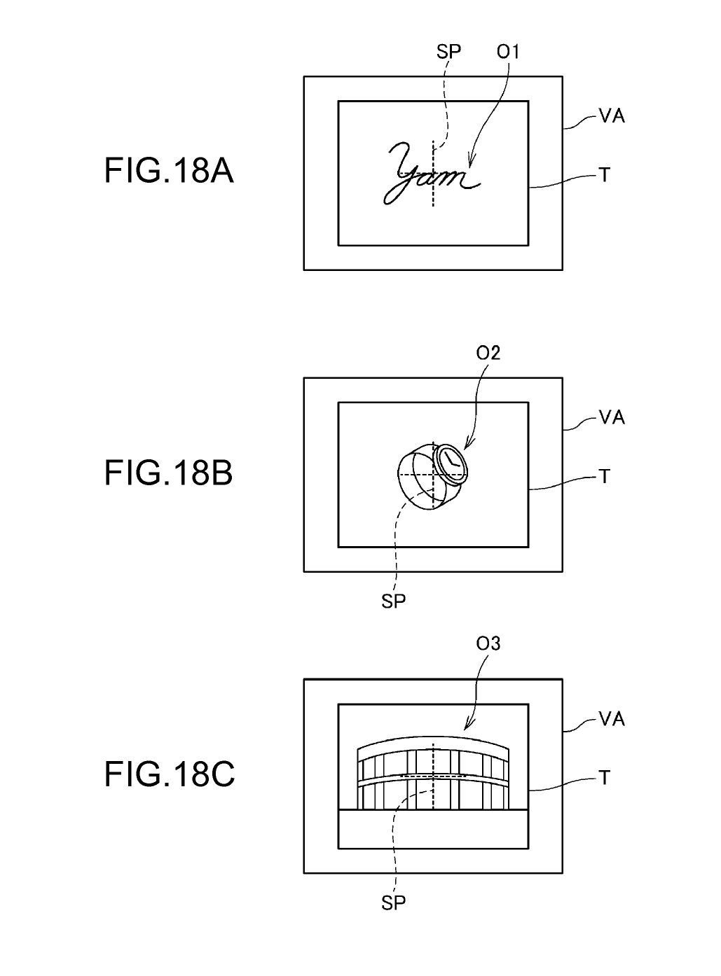

FIG. 16 is a flowchart for explaining the operation of the head-mounted display device 100 in a fifth embodiment. FIG. 17 is a diagram showing a configuration example of a user information table 120C stored in the storing unit 120 instead of the user information table 120A by the head-mounted display device 100 in the fifth embodiment. FIGS. 18A to 18C are diagrams showing examples of images that can be used for authentication in the head-mounted display device 100 in the fifth embodiment. FIG. 18A shows an example in which an image of a track of operation is used. FIG. 18B shows an example in which an image of a portable object is used. FIG. 18C shows an example in which an image of a building is used.

In the head-mounted display device 100 in the fifth embodiment, components common to the first embodiment are denoted by the same reference numerals and signs and illustration and explanation of the components are omitted.

In the first to fourth embodiments, the head-mounted display device 100 uses the biological information such as the palm line information in the processing for specifying the user. On the other hand, in the fifth embodiment, the head-mounted display device 100 uses information other than the biological information. Therefore, as shown in FIG. 17, a table referred to in authentication has a configuration in which not only the biological information but also general images can be used.

The user information table 120C shown in FIG. 17 stores registered image information concerning images used for the authentication and setting information in association with each other. The registered image information corresponds to the biological information in the user information table 120A and is associated with a user ID. The registered image information is information used when an image registered in advance is detected from picked-up images of the first camera 61 and the second camera 62 and coincidence with a detected image is determined.

In the user information table 120C illustrated in FIG. 17, data concerning a size and a feature value of an image detected from a picked-up image and a text and a code included in the image is included in the registered image information. The text and the code are a text recognizable by the control unit 140 through image recognition and information encoded by a barcode, a two-dimensional code, or the like. A type of the code is not limited as long as the control unit 140 can recognize the code from the picked-up image and decode the code. A unit of the size is optional. For example, as illustrated in FIG. 17, the size can be represented by the number of dots (the number of pixels) in the picked-up images of the first camera 61 and the second camera 62. The feature value is a feature value or the like of an image used for authentication. For example, when an image of an object is used for the authentication, feature values indicating a color, a shape, and other features of a picked-up image of the object are included in the user information table 120C. In this case, the setting unit 183 performs processing for extracting an image of the object from picked-up image data of the first camera 61 and/or the second camera 62, calculates a feature value of the extracted image, and compares and collates the calculated feature value and the feature value included in the user information table 120C. When the feature values are close to each other or are the same, the setting unit 183 can determine that the authentication is successful.

The user information table 120C can be generated by, for example, registering a picked-up image obtained by picking up an image of an object or the like instead of the image of the hand in the operation in the information registration mode explained with reference to FIG. 6 in the first embodiment.

That is, instead of the processing for displaying a silhouette image in step S1 in FIG. 6, a reference line SP (FIGS. 18A to 18C) serving as an index of the position of an image is displayed, image pickup is executed in step S2, and registered image information including a size and a feature value is calculated from the picked-up image in step S3. In step S4, setting information is calculated. In step S5, the setting information is stored in association with the registered image information.

In FIGS. 18A to 18C, examples of the image used for the authentication are shown. In FIG. 18A, a track of a hand of the user is used for the authentication. The control unit 140 displays the reference line SP in the display region T located in the visual field VA. The user moves a hand with reference to the reference line SP. The control unit 140 extracts an image of a track of the hand from a picked-up image picked up by the first camera 61 and/or the second camera 62 (hereinafter simply referred to as picked-up image). In the example shown in FIG. 18A, a track of the hand drawing a sign of a name “YAMADA” is shown. Concerning an image O1 of the track, the control unit 140 calculates a size and a feature value. The control unit 140 may execute image text recognition processing on the image O1 and obtain a text.

FIG. 18B shows an example in which an image of a clock is used for the authentication as the example in which the image of the portable object is used for the authentication. The user adjusts the direction of the face and the position of the clock such that the clock overlaps the position of the reference line SP in the display region T. The control unit 140 extracts an image O2 of the clock from a picked-up image and uses the image O2 for the authentication. Not only the clock but also an object that the user can hold by a hand while moving can be used for the authentication like the clock.

FIG. 18C shows an example in which an image of an un-portable object such as an immovable property and a scene is used for the authentication. In FIG. 18C, the user only has to move such that a building overlaps the reference line SP. In this case, the control unit 140 extracts an image O3 of the building or the scene from a picked-up image and calculates a size and a feature value.

As other examples, the object only has to be objects, images of which can be picked up by the first camera 61 or the second camera 62, such as an ID card on which a number and a code are printed, vehicles or mobile bodies such as an automobile and a bicycle, and clothes and ornaments.

As explained above, as the image used for the authentication in the fifth embodiment, movement of an object such as a hand can be used. An image of an object can be used irrespective of whether the object is portable or un-portable. The image is not limited to an image of specific one object and may be an image of a scene configured by a plurality of objects.

The user specifying mode shown in FIG. 16 can be executed in a state in which the user information table 120C is stored in the storing unit 120.

Processing in step S51 in FIG. 16 is the same as the processing in step S1 in FIG. 6 or step S11 in FIG. 8. The reference line SP is displayed instead of the silhouette image S. In the fifth embodiment, since the size and the shape of the image used for the authentication are various, for example, it is efficient to use the reference line SP indicating the center position like the reference line SP shown in FIGS. 18A to 18C.

The biological-information detecting unit 181 outputs the reference line SP to the display control unit 170 and causes the image display unit 20 to display the reference line SP (step S51). The user moves the hand while visually recognizing the reference line SP or moves to visually recognize the object and instructs image pickup. When detecting operation by the user, the biological-information detecting unit 181 causes the first camera 61 and/or the second camera 62 to execute the image pickup (step S52). A picked-up image is input to the biological-information detecting unit 181. The biological-information detecting unit 181 subjects the picked-up image to image processing and extracts image information for authentication (step S53).

In the user specifying mode, the image information is input to the setting unit 183 from the biological-information detecting unit 181.

When the image information is input from the biological-information detecting unit 181, the setting unit 183 selects image information used for collation processing (step S54). The setting unit 183 selects one or a plurality of kinds of image information used for collation out of the image information extracted by the biological-information detecting unit 181 (step S55). Consequently, the image information used for the collation is curtailed. After selecting the image information used for the collation, the setting unit 183 reads out, from the user information table 120C, registered image information, a size, a feature value, a text and a code, and the like of which coincide with or approximate to a size, a feature value, a text and a code, and the like of the selected image information, and performs the collation processing (step S56). When a plurality of kinds of image information are selected as the image information for the collation, in step S56, the setting unit 183 may perform the collation processing concerning the selected all kinds of image information.

The setting unit 183 determines, with the collation processing, whether the image information coincides with the registered image information (step S57). When determining that the image information does not coincide with the registered image information (NO in step S57), the setting unit 183 causes the image display unit 20 to additionally display guide indication on the reference line SP displayed by the image display unit 20 (step S58). As the guide indication, for example, a contour line of the image information determined as having high coincidence by the setting unit 183 in the collation processing can be used. After displaying the guide indication, the setting unit 183 returns to step S53.

When it is determined by the collation processing that the image information and the registered image information coincide with each other (YES in step S57), the setting unit 183 reads out setting information from the user information table 120C (step S59). The setting information is setting information associated with the registered image information determined as having high coincidence with the image information. The setting unit 183 calculates, on the basis of the read-out setting information, a correction coefficient for correcting a display position or a display size of display data. The setting unit 183 calculates, on the basis of at least one of an interocular distance, an angle of convergence, a relative distance of the eyes and the optical elements, and an angle of the optical elements, the correction coefficient for correcting the display position or the display size of the display data. After calculating the correction coefficient, the setting unit 183 outputs the calculated correction coefficient to the position detecting unit 185.

The position detecting unit 185 detects, concerning an image of a target object detected from the picked-up image by the object detecting unit 184, a position and a size with respect to a display region. After detecting the position and the size with respect to the display region, the position detecting unit 185 corrects the detected position and the detected size on the basis of the correction coefficient passed from the setting unit 183 (step S60). The information-display control unit 186 determines, concerning the target object detected by the target detecting unit 184, a display position of the display data on the basis of, for example, the position and/or the size corrected by the position detecting unit 185 on the basis of the correction coefficient. Thereafter, the information-display control unit 186 outputs the display data to the display control unit 170 and causes the image display unit 20 to execute display.

As explained above, in the head-mounted display device 100, instead of the biological information such as the palm line information explained in the first to fourth embodiments, the information related to the image extracted from the picked-up image of the object can be used for the authentication. Therefore, unlike when the biological information associated with a person in a one-to-one relation, it is possible to register a plurality of kinds of setting information in the user information table 120 in association with one perform. Therefore, the user can use a broader range of setting information.

The image information and the registered image information in the fifth embodiment are information other than the biological information and are information extracted, detected, or calculated from a picked-up image of an object. More specifically, the image information and the registered image information are information obtained on the basis of an image of the object extracted from the picked up image. The object includes an organism and includes a movable object, an unmovable object such as a building, and a scene including a plurality of objects. The information obtained on the basis of the image of the object (image information) does not include image features inherent in an individual organism such as a fingerprint, a palm print, and a facial feature. For example, it is desirable that the individual organism cannot be specified by the image information alone.

As another expression, examples of the image information include the external shape of an object shown in a picked-up image or the shape of an object obtained by extracting a contour, a color of the object shown in the picked-up image, a change in the shape of the object obtained from a plurality of picked-up images, and a track of the position of the object obtained from the plurality of picked-up images.

From these viewpoints, the image information exemplified as second identification information can be considered, for example, non biological inherent information with which individual identification of an organism is impossible. The image information can also be considered information including any one of exterior information obtained from the exterior of the object, outside scene image obtained by extracting information including the shape of a building from a picked-up building including the building as an object, object information for identification extracted from a picked-up image obtained by picking up an image of a non-biological object for identification, track information related to a track in continuous photographing of a moving object, and the like. However, the image information may be any information as long as the information does not include image features inherent in an individual organism such as a fingerprint, a palm print, and a facial feature.

### Sixth Embodiment

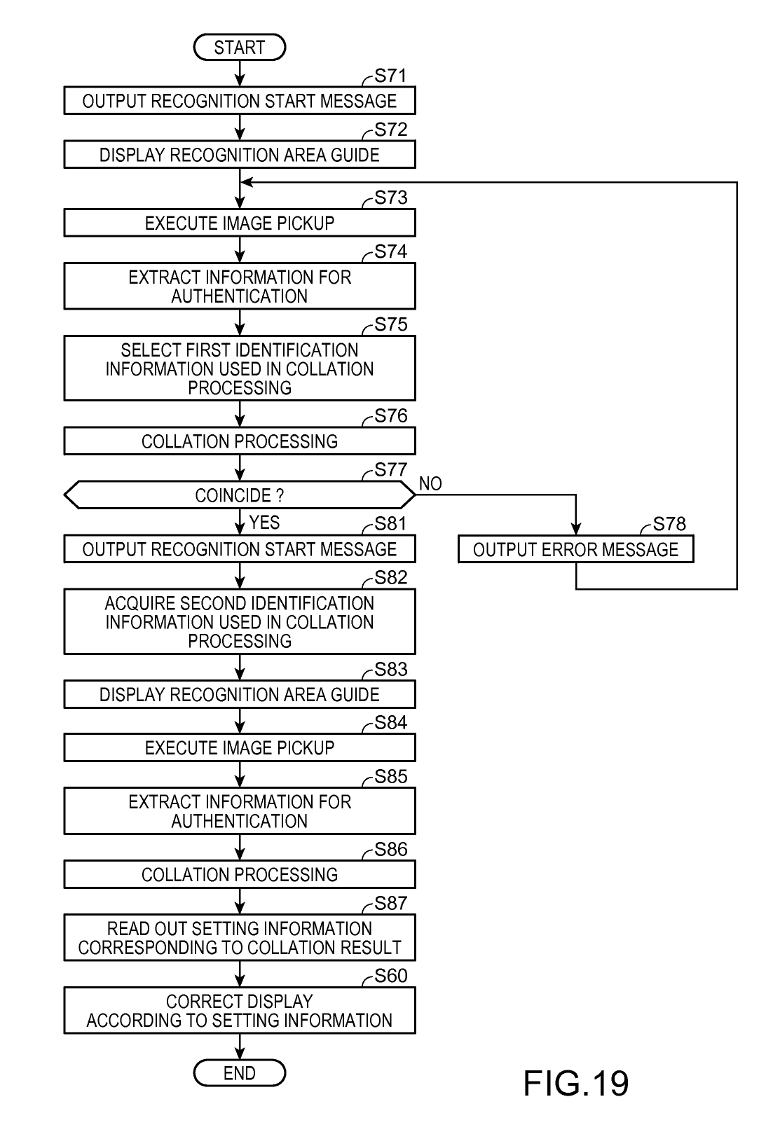

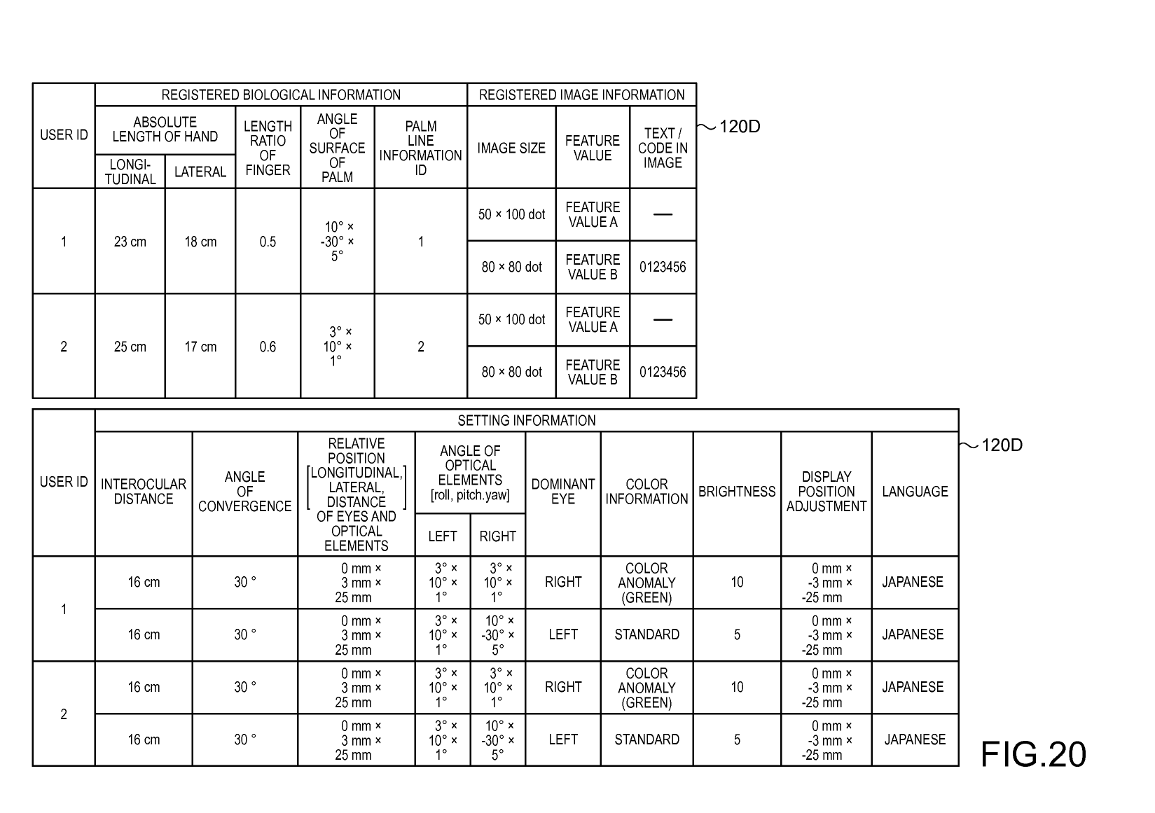

FIG. 19 is a flowchart for explaining the operation of the head-mounted display device 100 in a sixth embodiment. FIG. 20 is a diagram showing a configuration example of a user information table 120D stored in the storing unit 120 instead of the user information table 120A by the head-mounted display device 100 in the sixth embodiment. In the head-mounted display device 100 in the sixth embodiment, components common to the first embodiment are denoted by the same reference numerals and signs and illustration and explanation of the components are omitted.

In the first to fourth embodiments, the head-mounted display device 100 uses the biological information such as the palm line information in the processing for specifying the user. In the firth embodiment, the head-mounted display device 100 uses the information other than the biological information.

In the sixth embodiment, an example is explained in which the information other than the biological information explained in the fifth embodiment and the biological information explained in the first to fourth embodiments are combined and used for authentication.

In a table referred to in the authentication in the sixth embodiment, as shown in FIG. 20, setting information is registered in association with a combination of biological information and image information.

In the user information table 120D shown in FIG. 20, registered image information concerning an image used for the authentication and setting information are stored in association with each other. The registered image information corresponds to the biological information in the user information table 120A and is associated with a user ID. The registered image information is information used when an image registered in advance is detected from picked-up images of the first camera 61 and the second camera 62 and coincidence with a detected image is determined.

In the user information table 120D illustrated in FIG. 20, as in the user information table 120A (FIG. 5A), the registered biological information is registered in association with the user ID. In the user information table 120D, as in the user information table 120C (FIG. 17), the registered image information is registered in association with the user ID. The configurations of the registered biological information, the registered image information, and the setting information are the same as the configurations in the embodiments.

In the user information table 120D, the registered biological information is associated with one user ID. A plurality of kinds of registered image information are associated with the one user ID and the registered biological information. The setting information is registered in association with the registered biological information. In the user information table 120D, the setting information is registered in association with a combination of the registered biological information and the registered image information. For example, the same registered image information may be associated with different kinds of registered biological information.

Operation in performing the authentication using the user information table 120D is shown in FIG. 19. In FIG. 19, processing in step S60 is common to the processing explained with reference to FIG. 16 in the fifth embodiment.

In the operation shown in FIG. 19, two kinds of information, i.e., biological information and image information are collated with information registered in the user information table 120D. Setting information corresponding to a combination of the two kinds of information is read out. One of the biological information and the image information is collated first as first identification information. After the collation is successful, the other is collated as second identification information. The image information may be set as the first identification information and the biological information may be set as the second identification information and vice versa.

In the user information table 120D illustrated in FIG. 20, the same registered image information may be associated with different kinds of registered biological information. On the other hand, the biological information is uniquely associated with the user ID. Therefore, in the sixth embodiment, it is more desirable to collate the biological information as the first identification information. This example is explained below.

Processing in step S71 in FIG. 19 is processing same as step S1 in FIG. 6, step S11 in FIG. 8, or step S51 in FIG. 16. The silhouette image S or the reference line SP is displayed. In the example in which the biological information is used as the first identification information, the silhouette image S is displayed. Note that, in an example in which the image information is used as the first identification information, the reference line SP is displayed.

The biological-information detecting unit 181 outputs the silhouette image S to the display control unit 170 and causes the image display unit 20 to display the silhouette image S (step S72). The user adjusts the position of the hand and operates the operation unit 111 while visually recognizing the silhouette image S and instructs image pickup of an image of the hand R. When the operation of the operation unit 111 is input, the biological-information detecting unit 181 causes the first camera 61 to pick up an image of the hand R of the user (step S73). The picked-up image picked up by the first camera 61 is input to the biological-information detecting unit 181. The biological-information detecting unit 181 subjects the picked-up image to image processing and extracts biological information (step S74).

When input biological information is input from the biological-information detecting unit 181, the setting unit 183 selects biological information used for collation processing (step S75). The setting unit 183 selects one or a plurality of kinds of palm line information used for collation out of a plurality of kinds of palm line information included in the biological information, reads out, from the user information table, palm line information having a coordinate closest to a start point coordinate and an end point coordinate of the selected palm line information, and performs the collation processing (step S76).

The setting unit 183 performs collation of a length ratio and/or a curvature of the palm line information extracted from the user information table and a length ratio and/or a curvature of the palm line information selected from the input biological information. The setting unit 183 performs the collation processing for all the kinds of selected palm line information (step S77). When it is determined by the collation processing that a degree of coincidence of the length ratios and/or the curvatures is lower than a threshold, that is, the length ratios and/or the curvatures do not coincide with each other (NO in step S77), the setting unit 183 outputs an error message indicating that the authentication is unsuccessful (step S78) and returns to step S73. The setting unit 183 may cause the image display unit 20 to additionally display guide indication on the silhouette image S displayed by the image display unit 20. The guide indication is as explained concerning step S17 in FIG. 8.

When it is determined by the collation processing that the degree of coincidence of the length ratios and/or the curvatures is higher than the threshold (YES in step S77), the control unit 140 starts authentication of the image information, which is the second identification information (step S81). That is, the control unit 140 outputs a message for the start of the authentication of the image information.

The setting unit 183 acquires one or a plurality of kinds of image information registered in the user information table 120D in association with the biological information collated and determined as coinciding in step S76 (step S82). Consequently, it is possible to efficiently execute the authentication.

The biological-information detecting unit 181 outputs the reference line SP to the display control unit 170 and causes the image display unit 20 to display the reference line SP (step S83). The user moves the hand while visually recognizing the reference line SP or moves to visually recognize the object and instructs image pickup. When detecting operation by the user, the biological-information detecting unit 181 causes the first camera 61 and/or the second camera 62 to execute the image pickup (step S84). A picked-up image is input to the biological-information detecting unit 181. The biological-information detecting unit 181 subjects the picked-up image to image processing and extracts image information for authentication (step S85).

In the user specifying mode, the image information is input to the setting unit 183 from the biological-information detecting unit 181. When the image information is input from the biological-information detecting unit 181, the setting unit 183 collates the image information with registered image information, a size, a feature value, a text and a code, and the like of which coincide with or approximate to a size, a feature value, a text and a code, and the like of the input image information in the registered image information acquired in step S82 (step S86).

The setting unit 183 reads out, from the user information table 120D, setting information corresponding to the registered image information coinciding with the image information through the collation processing (step S87). The setting unit 183 calculates, on the basis of the read-out setting information, a correction coefficient for correcting a display position and a display size of display data. The setting unit 183 calculates, on the basis of at least one of an interocular distance, an angle of convergence, a relative distance of the eyes and the optical elements, and an angle of the optical elements, the correction coefficient for correcting the display position or the display size of the display data. After calculating the correction coefficient, the setting unit 183 outputs the calculated correction coefficient to the position detecting unit 185.

The position detecting unit 185 detects, concerning an image of a target object detected from the picked-up image by the object detecting unit 184, a position and a size with respect to a display region. After detecting the position and the size with respect to the display region, the position detecting unit 185 corrects the detected position and the detected size on the basis of the correction coefficient passed from the setting unit 183 (step S60). The information-display control unit 186 determines, concerning the target object detected by the target detecting unit 184, a display position of the display data on the basis of, for example, the position and/or the size corrected by the position detecting unit 185 on the basis of the correction coefficient. Thereafter, the information-display control unit 186 outputs the display data to the display control unit 170 and causes the image display unit 20 to execute display.

As explained in the sixth embodiment, by registering the setting information in the user information table 120D in association with a combination of the biological information and the image information, it is possible to store a plurality of kinds of setting information in association with one person. When these kinds of setting information are selected and used, by performing simple authentication, it is possible to secure security and realize setting appropriate for the user easily using the setting information.

In this configuration, the user can properly use the plurality of kinds of setting information stored in association with the biological information of the user. For example, after the authentication is performed using the palm line information, different kinds of setting information can be invoked and set when an image of running shoes is picked up by the first camera 61, when an image of a building is picked up by the first camera 61, and when the user moves the hand according to the sign of the name Therefore, it is possible to switch the setting information according to a use, a situation, a place, and the like in which the head-mounted display device 100 is used.

Since the setting information is specified in the two steps using the biological information and the image information, it is possible to store a larger number of kinds of setting and efficiently select and use the setting information.

In the sixth embodiment, the example is explained in which, as shown in FIG. 19, the setting unit 183 performs the collation first using the input biological information (the first identification information) input from the biological-information detecting unit 181, thereafter performs the collation using the image information (the second identification information) input from the biological-information detecting unit 181, and reads out the setting information.

More specifically, the input biological information serving as the first identification information is input and the setting unit 183 selects the input biological information and performs the collation processing (steps S72 to S77). Thereafter, the image information serving as the second identification information is input and the collation based on the image information is performed (step S83 to S86). The setting information is read out from the user information table 120D (step S87).

The embodiments of the invention are not limited to the configuration for executing the operation shown in FIG. 19. For example, before the operation in step S75, the setting unit 183 may perform the acquisition of the second identification information and the collation with the user information table 120D as in steps S83 to S86. Thereafter, the setting unit 183 may perform the operation in steps S72 to S77 to perform the collation using the first identification information and read out the setting information in step S87 on the basis of a result of the collation. In this case, it is possible to obtain effects same as the effects of the configuration explained in the sixth embodiment.

The configurations in the first to sixth embodiments are not only respectively independently carried out but also can be applied in combination.

In the first embodiment, the example is explained in which the head-mounted display device 100 performs the authentication using the biological information serving as the identification information and controls the display using the setting information stored in association with the biological information. In the second embodiment, the operation for seeking confirmation of the user when the head-mounted display device 100 succeeds in the authentication performed using the identification information. In the third embodiment, the operation for using the monocular display as the display in the image display unit 20 before the setting based on the setting information specified on the basis of the identification information is performed. In the fourth embodiment, the example is explained in which, when the head-mounted display device 100 fails in the collation of the biological information serving as the identification information, the new registration or the like is executed according to the input operation by the user. In the fifth embodiment, the example is explained in which the head-mounted display device 100 performs the authentication using the information other than the biological information, for example, general information as the identification information, specifies the stored setting information, and controls the display of the image display unit 20. In the sixth embodiment, the example is explained in which the information other than the biological information explained in the fifth embodiment and the biological information explained in the first to fourth embodiments are combined and used for the authentication. In the fifth and sixth embodiments, as the example of the user information table stored in the storing unit 120, the user information table in which the setting information is registered in association with the combination of the biological information and the image information is explained.

The invention can be executed by combining the configurations explained in the embodiments. For example, as explained in the fifth and sixth embodiments, in the configuration in which the information other than the biological information is used, as explained in the third embodiment, the monocular display may be performed before the display of the image display unit 20 is controlled on the basis of the setting information. For example, in the configurations in the third, fifth, and sixth embodiments, as explained in the second embodiment, when the head-mounted display device 100 succeeds in the authentication, the operation for seeking configuration of the user may be performed. For example, for example, in the configurations in the third, fifth, and sixth embodiments, as explained in the fourth embodiment, when the head-mounted display device 100 fails in the collation of the identification information, the new registration or the like may be executed according to the input operation by the user. Further, embodiments applied with the invention can also be combinations of configurations other than the configurations illustrated above. Selection of the combinations of the configurations is not limited.

Note that the invention is not limited to the configurations in the embodiments and can be carried out in various forms without departing from the spirit of the invention.

For example, instead of the image display unit 20, for example, image display units of other types such as an image display unit worn like a hat may be adopted. The image display units only have to include a display unit that displays an image corresponding to the left eye of the user and a display unit that displays an image corresponding to the right eye of the user. The display device according to the invention may be configured as, for example, a head mounted display mounted on vehicles such as an automobile and an airplane. The display device may be configured as, for example, a head mounted display incorporated in a body protector such as a helmet or may be configured as a head-up display (HUD) used in a windshield of an automobile.

Further, in the embodiment, the configuration in which the image display unit 20 and the control device 10 are separated and connected via the connecting unit 40 is explained as the example. However, it is also possible to adopt a configuration in which the control device 10 and the image display unit 20 are integrated and worn on the head of the user.

When the control device 10 and the image display unit 20 are connected by a longer cable, a notebook computer, a tablet computer, and a desktop computer may be used as the control device 10. Portable electronic devices including a game machine, a cellular phone, a smart phone, and a portable media player, other dedicated devices, and the like may be used as the control device 10.

For example, as a component that generates image light in the image display unit 20, the image display unit 20 may include an organic EL (electroluminescence) display and an organic EL control unit. As the component that generates image light, a LCOS (Liquid crystal on silicon; LCoS is a registered trademark), a digital micro mirror device, and the like can also be used. For example, the invention can also be applied to a head mounted display of a laser retinal projection type. That is, a configuration may be adopted in which an image generating unit includes a laser beam source and an optical system that guides a laser beam to the eyes of a user and the laser beam is made incident on the eyes of the user to scan the retinas and focused on the retinas to cause the user to visually recognize an image. When the head mounted display of the laser retinal projection type is adopted, “a region where image light can be emitted in an image-light generating unit” can be defined as an image region visually recognized by the eyes of the user.

As the optical system that guides the image light to the eyes of the user, it is possible to adopt a component that includes an optical member for transmitting external light made incident on the device from the outside and makes the external light incident on the eyes of the user together with the image light. An optical member located in front of the eyes of the user and overlapping a part or the entire visual field of the user may be used. Further, an optical system of a scanning type for scanning a laser beam or the like as the image light may be adopted. The optical system is not limited to an optical system that guides the image light on the inside of an optical member and may be an optical system including only a function of refracting and/or reflecting the image light and guiding the image light to the eyes of the user.

The invention can also be applied to a display device in which a scanning optical system including a MEMS mirror is adopted and a MEMS display technique is used. That is, as image display elements, a signal-light forming unit, a scanning optical system including a MEMS mirror for scanning light emitted by the signal-light forming unit, and an optical member on which a virtual image is formed by light scanned by the scanning optical system may be included. In this configuration, the light emitted by the signal-light forming unit is reflected by the MEMS mirror, made incident on the optical member, and guided in the optical member to reach a virtual-image forming surface. The MEMS mirror scans the light, whereby a virtual image is formed on the virtual-image forming surface. The user catches the virtual image with the eyes to recognize an image. Optical components in this case may be optical components that guide the light through a plurality of times of reflection like, for example, the right light guide plate 261 and the left light guide plate 262 in the embodiments. Half mirror surfaces may be used.

Further, the optical elements according to the invention are not limited to the right light guide plate 261 and the left light guide plate 262 including the half mirrors 261A and 262A and only have to be optical components that make the image light incident on the eyes of the user. Specifically, a diffraction grating, a prism, and a holography display unit may be used.

The display device according to the invention is not limited to the display device of the head mounted type and can be applied to various display devices such as a flat panel display and a projector. The display device according to the invention only has to be a display device that causes the user to visually recognize an image using the image light together with the external light. For example, the display device according to the invention is a display device that causes the user to visually recognize an image by the image light using an optical member that transmits the external light. Specifically, besides the head mounted display including the optical member that transmits the external light, the invention can also be applied to a display device that projects the image light on a light-transmitting plane or curved surface (glass, transparent plastics, etc.) set fixedly or movably in a position apart from the user. As an example, the display device is a display device that projects the image light on window glass of a vehicle and causes a user in the vehicle or a user outside the vehicle to visually recognize scenes inside and outside the vehicle. The display device is, for example, a display device that projects the image light on a fixedly set transparent or semitransparent or colored-transparent display surface such as window glass of a building and causes a user present around the display surface to visually recognize a scene through the display surface together with an image formed by the image light.

At least a part of the functional blocks shown in FIG. 4 may be realized by hardware or may be realized by cooperation of the hardware and software and is not limited to the configuration in which the independent hardware resources are disposed as shown in FIG. 2. The computer program executed by the control unit 140 may be stored in the storing unit 120 or the storage device in the control device 10. The computer program stored in an external device may be acquired via the communication unit 117 or the interface 125 and executed. Among the components formed in the control device 10, only the operation unit 111 may be formed as an independent user interface (UI). The components formed in the control device 10 may be redundantly formed in the image display unit 20. For example, the control unit 140 shown in FIG. 4 may be formed in both of the control device 10 and the image display unit 20. Functions performed by the control unit 140 formed in the control device 10 and the CPU formed in the image display unit 20 may be separated.

As the setting information, information concerning a color of the pupils of the user may be registered in the user information table 120A in advance. The intensity and the color scheme of the image light output from the display driving units 22 and 24 may be changed according to the color of the pupils of the user. Body shape information (standard, slim, or fat) of the user may be registered in the user information table 120A in advance. The color scheme of the image light output from the display driving units 22 and 24 may be changed according to the body shape of the user. For example, if the user is fat, when the image display unit 20 displays an image of foods, a color of the image may be changed to a bluish color. This makes it possible to suppress appetite of the user. Shades, the transmittance of which is changeable, may be provided in the right optical-image display unit 26 and the left optical-image display unit 28. The transmittance of the shades may be changed according to the color of the pupils of the user.

As the setting information, physical features such as the height, the weight, and the sex of the user may be registered in the user information table 120A in advance. The display position and/or the display size in the display region of the image display unit 20 may be corrected on the basis of the physical features of the user.

The entire disclosure of Japanese Patent Application Nos. 2014-217270, filed Oct. 24, 2014 and 2015-124440, filed Jun. 22, 2015 are expressly incorporated by reference herein.

What is claimed is:

1. A display device including a display unit of a head mounted type, the display device comprising:
a storing unit configured to store setting information concerning display of the display unit in association with identification information for identifying a user;
an input unit configured to input the identification information; and
a control unit configured to control the display of the display unit on the basis the setting information corresponding to the input identification information.

2. The display device according to claim 1, further comprising an image pickup unit, wherein
the input unit inputs the identification information based on a picked-up image picked up by the image pickup unit, and
the control unit specifies the identification information corresponding to the identification information input by the input unit among the identification information stored in the storing unit and controls the display of the display unit on the basis of the setting information stored in association with the specified identification information.

3. The display device according to claim 1, wherein the identification information includes a part of features included in biological information of the user.

4. The display device according to claim 3, wherein the control unit collates a part of the features of the biological information input as the identification information by the input unit and a part of the features of the biological information stored by the storing unit to specify the setting information.

5. The display device according to claim 2, wherein the identification information includes image information related to an image extracted from the picked-up image picked up by the image pickup unit.

6. The display device according to claim 5, wherein the control unit collates the image information included in the identification information input by the input unit and the image information stored by the storing unit to specify the setting information.

7. The display device according to claim 5, wherein
the identification information includes first identification information including a part of features included in biological information of the user and second identification information configured by the image information, and
the storing unit stores the first identification information, the second identification information, and the setting information in association with one another.

8. The display device according to claim 7, wherein the control unit specifies, on the basis of the first identification information and the second identification information included in the identification information input by the input unit, the setting information stored in the storing unit.

9. The display device according to claim 8, wherein the control unit specifies the setting information stored in the storing unit in association with a combination of the first identification information and the second identification information included in the identification information input by the input unit.

10. The display device according to claim 7, wherein the control unit selects, on the basis of one of the first identification information and the second identification information included in the identification information input by the input unit, a plurality of kinds of the setting information from the setting information stored in the storing unit and specifies, among the selected setting information, the setting information corresponding to the other of the first identification information and the second identification information included in the identification information input by the input unit.

11. The display device according to claim 5, wherein the image information is information extractable or detectable from the picked-up image and is non biological inherent information not including information, which alone enables individual identification of an organism.

12. The display device according to claim 11, wherein the image information includes any one of outside scene information obtained by extracting information including a shape of a building from the picked-up image including the building, object information for identification extracted from the picked-up image obtained by picking up an image of a non-biological object for identification, and track information related to a track of an object extracted from a plurality of the picked-up images obtained by picking up images of a moving object.

13. The display device according to claim 1, wherein
the display unit is capable of switching and executing binocular display for displaying an image to correspond to a right eye and a left eye of the user and monocular display for displaying an image to correspond to one of the right eye and the left eye of the user, and
the control unit causes, on the basis of the setting information corresponding to the identification information input by the input unit, the display unit to perform monocular display before controlling the display of the display unit and switch the display unit to binocular display when controlling the display on the basis of the setting information.

14. The display device according to claim 1, wherein the display unit transmits an outside scene and displays an image to be visually recognizable together with the outside scene, and
the control unit changes at least one of a display position and a display size of the image in a plurality of steps according to the setting information.

15. The display device according to according to claim 1, wherein
the display unit includes:
an optical element that transmits an outside scene and makes image light incident on the eyes of the user to be visually recognizable together with the outside scene;
a target detecting unit that detects a target object in a visual line direction of the user; and
a position detecting unit that detects a position of the target object with respect to a display region of the display unit, and
the control unit changes a display position of the image by the optical element according to a position of the target object detected by the position detecting unit and a positional relation between the optical element and positions of the pupils of the user.

16. The image display device according to claim 1, wherein
the setting information includes information concerning setting of a language, and
the control unit causes the display unit to display characters of the language corresponding to the setting information when displaying contents including characters on the display unit.

17. The display device according to claim 1, further comprising a communication unit, wherein
the control unit transmits, with the communication unit, the setting information and the identification information stored in the storing unit to an external apparatus in association with each other, receives the setting information and the identification information with the communication unit, and stores the received setting information and the received identification information in the storing unit in association with each other.

18. A display system comprising a plurality of display devices, each including a display unit of a head mounted type, wherein
the display device includes:
a storing unit configured to store setting information concerning display of the display unit in association with identification information for identifying a user;
an input unit configured to input the identification information;
a control unit configured to control the display of the display unit on the basis the setting information corresponding to the input identification information; and
a communication unit configured to communicate with the other display devices, and
the control unit transmits, with the communication unit, the setting information and the identification information stored in the storing unit in association with each other, receives the setting information and the identification information with the communication unit, and stores the received setting information and the received identification information in the storing unit in association with each other.

19. A control method for a display device including a display unit of a head mounted type, the control method comprising:
inputting identification information;
controlling, referring to a storing unit that stores setting information concerning display of the display unit in association with identification information for identifying a user, the display of the display unit on the basis of the setting information corresponding to the input identification information.

20. A computer program executable by a computer that controls a display device including a display unit of a head mounted type, the computer program causing the computer to function as:
an input unit configured to input identification information; and
a control unit configured to control, referring to a storing unit that stores setting information concerning display of the display unit in association with identification information for identifying a user, the display of the display unit on the basis of the setting information corresponding to the input identification information.
